(19) United States
(12) Patent Application Publication
(10) Pub. No.: US 2026/0107200 A1
(43) Pub. Date: Apr. 16, 2026

(54) TECHNIQUES FOR SPEED-DEPENDENT CELL RESELECTION

(71) Applicant: QUALCOMM Incorporated, San Diego, CA (US)

(72) Inventors: Navid ABEDINI, Basking Ridge, NJ (US); Jianghong LUO, Skillman, NJ (US)

(21) Appl. No.: 19/334,522

(22) Filed: Sep. 19, 2025

Related U.S. Application Data
(60) Provisional application No. 63/707,124, filed on Oct. 14, 2024.

(51) Int. Cl. H04W 36/00; H04W 36/08

(52) U.S. Cl. CPC H04W 36/0085; H04W 36/00837; H04W 36/08

(57) ABSTRACT

Methods, systems, and devices for wireless communications are described. A user equipment (UE) may receive control signaling from a first cell indicating a cell reselection configuration to reduce triggering of (e.g., disincentivize) cell reselection procedures at the UE based on a mobility state of the UE satisfying a threshold mobility state. The cell reselection configuration may include a set of conditions for determining one or more scaling factors based on the mobility state of the UE, where the scaling factors are usable for determining whether or not to perform cell reselection procedures at the UE. The UE may then perform performing measurements on signals received from a second cell, and determine whether or not to perform a cell reselection procedure from the first cell to the second cell based on the measurements and the one or more scaling factors of the cell reselection configuration.

### CROSS REFERENCES

The present application for patent claims benefit of U.S. Provisional Patent Application No. 63/707,124 by ABEDINI et al., entitled “TECHNIQUES FOR SPEED-DEPENDENT CELL RESELECTION,” filed Oct. 14, 2024, assigned to the assignee hereof, and hereby expressly incorporated by reference herein in its entirety as if fully set forth below and for all applicable purposes.

### FIELD OF TECHNOLOGY

The following relates to wireless communications, including techniques for speed-dependent cell reselection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless networks, UEs may be configured to perform cell reselection procedures to switch between different serving cells as the UEs move throughout the network. When evaluating whether or not to perform a cell reselection procedure from one serving cell to another, a UE may perform measurements (e.g., reference signal received power (RSRP), reference signal received quality (RSRQ)) on signals received from the respective serving cells, and may therefore determine cell reselection criteria that are used to determine whether or not the UE will perform cell reselection. The network may configure UEs with a cell reselection configuration that defines how the UE is to calculate the cell reselection criteria.

### SUMMARY

The systems, methods, and devices of this disclosure each have several innovative aspects, no single one of which is solely responsible for the desirable attributes disclosed herein.

A method by a user equipment (UE) is described. The method may include receiving, from a first cell, control signaling indicating a cell reselection configuration to reduce triggering of cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE, performing measurements on signals received from a second cell, and performing, or refraining from performing, a cell reselection procedure from the first cell to the second cell based on the measurements and the one or more scaling factors of the cell reselection configuration.

A UE is described. The UE may include one or more memories storing processor executable code, and one or more processors coupled with the one or more memories. The one or more processors may individually or collectively be operable to execute the code to cause the UE to receive, from a first cell, control signaling indicating a cell reselection configuration to reduce triggering of cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE, perform measurements on signals received from a second cell, and perform, or refraining from performing, a cell reselection procedure from the first cell to the second cell based on the measurements and the one or more scaling factors of the cell reselection configuration.

Another UE is described. The UE may include means for receiving, from a first cell, control signaling indicating a cell reselection configuration to reduce triggering of cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE, means for performing measurements on signals received from a second cell, and means for performing, or refraining from performing, a cell reselection procedure from the first cell to the second cell based on the measurements and the one or more scaling factors of the cell reselection configuration.

A non-transitory computer-readable medium storing code is described. The code may include instructions executable by one or more processors to receive, from a first cell, control signaling indicating a cell reselection configuration to reduce triggering of cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE, perform measurements on signals received from a second cell, and perform, or refraining from performing, a cell reselection procedure from the first cell to the second cell based on the measurements and the one or more scaling factors of the cell reselection configuration.

In some examples of the method, UEs, and non-transitory computer-readable medium described herein, the one or more scaling factors may be usable for calculating one or more cell reselection criteria and the method, apparatuses, and non-transitory computer-readable medium may include further operations, features, means, or instructions for determining a negative scaling factor for calculating the cell signal strength metric, the cell signal quality metric, the cell ranking metric, or any combination thereof, in accordance with the set of conditions and based on the mobility state of the UE, where refraining from performing the cell reselection procedure may be based on the negative scaling factor.

In some examples of the method, user equipment (UEs), and non-transitory computer-readable medium described herein, the one or more scaling factors may be usable for calculating one or more cell reselection criteria and the method, apparatuses, and non-transitory computer-readable medium may include further operations, features, means, or instructions for determining a scaling factor that may be greater than one for calculating the cell reselection timer in accordance with the set of conditions and based on the mobility state of the UE, where refraining from performing the cell reselection procedure may be based on the scaling factor that may be greater than one.

Some examples of the method, UEs, and non-transitory computer-readable medium described herein may further include operations, features, means, or instructions for performing additional measurements on signals received from the first cell and determining the mobility state of the UE based on a comparison between the additional measurements and the one or more thresholds.

In some examples of the method, UEs, and non-transitory computer-readable medium described herein, the one or more thresholds may be associated with a rate of change, a magnitude of change, or both, of the additional measurements performed on the signals received from the first cell.

Some examples of the method, UEs, and non-transitory computer-readable medium described herein may further include operations, features, means, or instructions for determining one or more cell reselection criteria based on the one or more scaling factors, the one or more cell reselection criteria including a cell signal strength metric or a cell signal quality metric associated with the first cell, the second cell, or both, a cell reselection timer associated with an evaluation of the cell reselection procedure, a cell ranking metric associated with the first cell or the second cell, or any combination thereof.

Some examples of the method, UEs, and non-transitory computer-readable medium described herein may further include operations, features, means, or instructions for receiving a second cell reselection configuration to increase triggering of cell reselection procedures at the UE based on the mobility state of the UE, the second cell reselection configuration including a second set of conditions for determining the one or more scaling factors based on the mobility state of the UE, where performance, or lack of performance, of the cell reselection procedure may be based on the cell reselection configuration or the second cell reselection configuration.

Some examples of the method, UEs, and non-transitory computer-readable medium described herein may further include operations, features, means, or instructions for selecting one of the cell reselection configuration or the second cell reselection configuration based on the mobility state of the UE satisfying one or more mobility state thresholds, where performance, or lack of performance, of the cell reselection procedure may be based on the selecting.

Some examples of the method, UEs, and non-transitory computer-readable medium described herein may further include operations, features, means, or instructions for receiving a paging message from the first cell, where selecting one of the cell reselection configuration or the second cell reselection configuration may be based on the paging message.

Some examples of the method, UEs, and non-transitory computer-readable medium described herein may further include operations, features, means, or instructions for selecting one of the cell reselection configuration or the second cell reselection configuration may be based on a priority, a quality of service (QoS), or both, associated with communications to be performed by the UE.

In some examples of the method, UEs, and non-transitory computer-readable medium described herein, the UE may be configured to refrain from performing the cell reselection procedure based on the mobility state of the UE exceeding the threshold mobility state, and based on the UE operating in an idle operational state or an inactive operational state.

Some examples of the method, UEs, and non-transitory computer-readable medium described herein may further include operations, features, means, or instructions for communicating with the first cell based on refraining from performing the cell reselection procedure and communicating with the second cell based on performing the cell reselection procedure.

A method by a first cell is described. The method may include transmitting, to a UE, control signaling indicating a cell reselection configuration to reduce triggering of cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE and performing, or refraining from performing, a cell reselection procedure for the UE from the first cell to a second cell based on the one or more scaling factors of the cell reselection configuration.

A first cell is described. The first cell may include one or more memories storing processor executable code, and one or more processors coupled with the one or more memories. The one or more processors may individually or collectively be operable to execute the code to cause the first cell to transmit, to a UE, control signaling indicating a cell reselection configuration to reduce triggering of cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE and perform, or refraining from performing, a cell reselection procedure for the UE from the first cell to a second cell based on the one or more scaling factors of the cell reselection configuration.

Another first cell is described. The first cell may include means for transmitting, to a UE, control signaling indicating a cell reselection configuration to reduce triggering of cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE and means for performing, or refraining from performing, a cell reselection procedure for the UE from the first cell to a second cell based on the one or more scaling factors of the cell reselection configuration.

A non-transitory computer-readable medium storing code is described. The code may include instructions executable by one or more processors to transmit, to a UE, control signaling indicating a cell reselection configuration to reduce triggering of cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE and perform, or refraining from performing, a cell reselection procedure for the UE from the first cell to a second cell based on the one or more scaling factors of the cell reselection configuration.

Some examples of the method, first cells, and non-transitory computer-readable medium described herein may further include operations, features, means, or instructions for set of conditions for determining the one or more scaling factors include one or more thresholds for evaluating the mobility state of the UE and the one or more thresholds may be associated with a rate of change, a magnitude of change, or both, of measurements performed by the UE on signals received from the first cell.

In some examples of the method, first cells, and non-transitory computer-readable medium described herein, the one or more scaling factors may be usable for determining one or more cell reselection criteria for evaluating the cell reselection procedure, the one or more cell reselection criteria including a cell signal strength metric or a cell signal quality metric associated with the first cell, the second cell, or both, a cell reselection timer associated with an evaluation of the cell reselection procedure, a cell ranking metric associated with the first cell or the second cell, or any combination thereof.

Some examples of the method, first cells, and non-transitory computer-readable medium described herein may further include operations, features, means, or instructions for transmitting, to the UE, a second cell reselection configuration to increase triggering reselection procedures at the UE based on the mobility state of the UE, the second cell reselection configuration including a second set of conditions for determining the one or more scaling factors based on the mobility state of the UE, where performance, or lack of performance, of the cell reselection procedure may be based on the cell reselection configuration or the second cell reselection configuration.

Some examples of the method, first cells, and non-transitory computer-readable medium described herein may further include operations, features, means, or instructions for transmitting, to the UE, a paging message including information for selecting one of the cell reselection configuration or the second cell reselection configuration, where performance, or lack of performance, of the cell reselection procedure may be based on the paging message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for speed-dependent cell reselection in accordance with one or more aspects of the present disclosure.

FIG. 2 shows an example of a wireless communications system that supports techniques for speed-dependent cell reselection in accordance with one or more aspects of the present disclosure.

FIG. 3 shows an example of a cell reselection evaluation that supports techniques for speed-dependent cell reselection in accordance with one or more aspects of the present disclosure.

FIG. 4 shows an example of a process flow that supports techniques for speed-dependent cell reselection in accordance with one or more aspects of the present disclosure.

FIGS. 5 and 6 show block diagrams of devices that support techniques for speed-dependent cell reselection in accordance with one or more aspects of the present disclosure.

FIG. 7 shows a block diagram of a communications manager that supports techniques for speed-dependent cell reselection in accordance with one or more aspects of the present disclosure.

FIG. 8 shows a diagram of a system including a device that supports techniques for speed-dependent cell reselection in accordance with one or more aspects of the present disclosure.

FIGS. 9 and 10 show block diagrams of devices that support techniques for speed-dependent cell reselection in accordance with one or more aspects of the present disclosure.

FIG. 11 shows a block diagram of a communications manager that supports techniques for speed-dependent cell reselection in accordance with one or more aspects of the present disclosure.

FIG. 12 shows a diagram of a system including a device that supports techniques for speed-dependent cell reselection in accordance with one or more aspects of the present disclosure.

FIGS. 13 through 15 show flowcharts illustrating methods that support techniques for speed-dependent cell reselection in accordance with one or more aspects of the present disclosure.

### DETAILED DESCRIPTION

In some wireless networks, user equipments (UEs) and other wireless devices may be configured to perform cell reselection procedures to switch between different serving cells as the UEs move throughout the network. When evaluating whether or not to perform a cell reselection procedure from one serving cell to another, a UE may perform measurements (e.g., reference signal received power (RSRP), reference signal received quality (RSRQ)) on signals received from the respective serving cells, and use the measurements to calculate cell reselection criteria that are used to determine whether or not the UE will perform cell reselection. The network may configure UEs with a cell reselection configuration that defines how the UE is to calculate the cell reselection criteria. In some networks, cell reselection configurations are designed to incentivize cell reselection by reducing complexity and/or latency for the UE to perform cell reselection (e.g., increase the probability/likelihood that a UE can/will perform a cell reselection procedure), particularly for UEs that are in a high mobility state. That is, for UEs that are in a high mobility state, some cell reselection configurations may reduce complexity for such UEs to quickly and frequently move from cell to cell.

However, such cell reselection configurations may result in increased control signaling and/or additional power consumption at the UE and the network. For example, cell reselection configurations that incentivize UEs to perform cell reselection may increase the quantity of cell reselections within the network, thereby increasing control signaling and network congestion. Moreover, it may not always be advantageous for UEs to perform cell reselection. For example, in cases where a UE is moving quickly (e.g., high mobility state) while in an idle/inactive operational state, it may not be advantageous for the UE to perform cell reselection because the UE may quickly move out of range of the new cell (due to the high mobility state) and/or because the UE does not need to perform communications while in the idle/inactive state. Further, some networks may implement network energy saving (NES) techniques, where some serving cells operate in a NES state (e.g., low-power or inactive state) until there are wireless devices (e.g., UEs) that request to connect to the serving cells. In such cases, cell reselection configurations that incentivize UEs to perform cell reselection may cause serving cells to frequently transition out of NES states, thereby increasing the power consumption at the network.

Accordingly, aspects of the present disclosure are directed to new cell reselection configurations that are intended to disincentivize cell reselection procedures at UEs when the mobility states of the UEs satisfy (e.g., exceed) some threshold. That is, aspects of the present disclosure are directed to new cell reselection configurations that are used to calculate cell reselection criteria in a way that reduces the probability/likelihood that the UE will perform a cell reselection procedure. For example, a UE may be configured with a new cell reselection configuration associated with a set of conditions for calculating scaling factors used for evaluating cell reselection, where the set of conditions are based on the mobility state of the UE. In particular, using the new cell reselection configuration, the UE may calculate SFs (and cell reselection criteria based on the scaling factors) in a manner that reduces the probability/likelihood that the UE will perform cell reselection in cases where the UE exhibits a (relatively) high mobility state. In some cases, the UE may be configured with multiple cell reselection configurations (e.g., a “new” cell reselection configuration, and a “legacy” cell reselection configuration), and may evaluate cell reselection using one of the configured cell reselection configurations based on explicit signaling from the network, based on a priority of communications to be performed by the UE, etc.

Additionally, aspects of the present disclosure are directed to new conditions that are used to evaluate mobility states at the UE. In other words, some aspects of the present disclosure are directed to configurations and techniques that redefine how the mobility state of the UE is calculated. For example, instead of the mobility state of the UE being based on the quantity of cell reselections performed by the UE, the mobility state may be based on (1) the actual speed/velocity of the UE, or (2) the rate or amount of change of measurements performed by the UE (e.g., rate/magnitude of changes in RSRP measurements may be used as a proxy for speed and mobility state).

Techniques described herein may be used to better tailor cell reselection procedures performed by a UE to the mobility state of the UE to strike a balance between power savings at the UE and network, and a quality of communications at the UE. In particular, a new cell reselection procedure may adjust how scaling factors and cell reselection criteria are calculated in order to disincentivize UEs in high mobility states from performing cell reselection, which may reduce the quantity and frequency of cell reselection procedures performed within the network. By reducing the quantity and/or frequency of cell reselection procedures, techniques described herein may reduce control signaling overhead within the network, thereby improving resource utilization and increasing the reliability of wireless communications. Further, by reducing the quantity and/or frequency of cell reselection procedures, techniques described herein may reduce power consumption at the UEs (e.g., by reducing power spent on cell reselection) and the network (e.g., by enabling serving cells to remain in NES states for longer periods of time).

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to techniques for speed-dependent cell reselection.

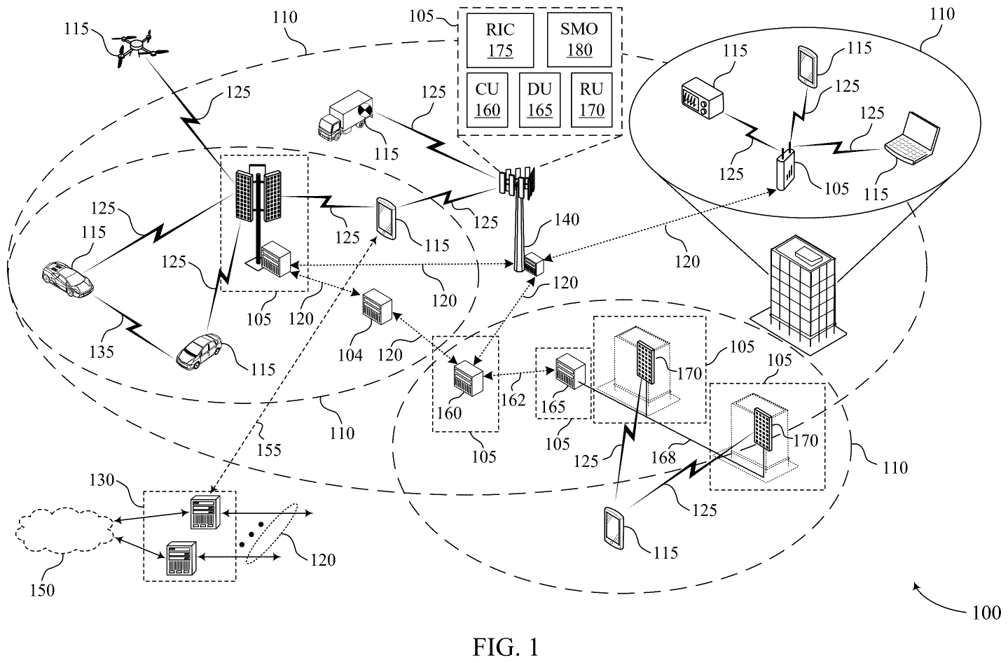

FIG. 1 shows an example of a wireless communications system 100 that supports techniques for speed-dependent cell reselection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for speed-dependent cell reselection as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the respective wireless devices of the wireless communications system 100 (e.g., UEs 115, network entities 105, IoT devices, IAB nodes, etc.) may support cell reselection configurations that are intended to disincentivize cell reselection procedures at UEs 115 when the mobility states of the UEs 115 satisfy (e.g., exceed) some threshold mobility state. That is, the wireless communications system 100 may support new cell reselection configurations that are used to calculate cell reselection criteria in a way that reduces the probability/likelihood that UEs 115 will perform a cell reselection procedure. For example, a UE 115 of the wireless communications system 100 may be configured by the network with a new cell reselection configuration associated with a set of conditions for calculating scaling factors used for evaluating cell reselection (e.g., scaling factors are usable for determining whether or not to perform cell reselection), where the set of conditions are based on the mobility state of the UE 115. In particular, using the new cell reselection configuration, the UE 115 may calculate scaling factors (and cell reselection criteria based on the scaling factors) in a manner that reduces the probability/likelihood that the UE 115 will perform cell reselection in cases where the UE 115 exhibits a (relatively) high mobility state. I

In some cases, the network may configure the UE 115 multiple cell reselection configurations (e.g., a “new” cell reselection configuration, and a “legacy” cell reselection configuration), where the UE 115 may evaluate cell reselection using one of the configured cell reselection configurations based on explicit signaling from the network, based on a priority of communications to be performed by the UE 115, etc.

Additionally, the wireless communications system 100 may support additional or alternative conditions that are used to evaluate mobility states at the UE 115. In other words, some aspects of the present disclosure are directed to configurations and techniques that redefine how the mobility state of the UE 115 is calculated. For example, instead of the mobility state of the UE 115 being based on the quantity of cell reselections performed by the UE 115, the mobility state may be based on (1) the actual speed/velocity of the UE 115, or (2) the rate or amount of change of measurements performed by the UE 115 (e.g., rate/magnitude of changes in RSRP measurements may be used as a proxy for speed and mobility state).

Techniques described herein may be used to better tailor cell reselection procedures performed by a UE 115 to the mobility state of the UE 115 to strike a balance between power savings at the UE 115 and network, and a quality of communications at the UE 115. In particular, a new cell reselection procedure may adjust how scaling factors and cell reselection criteria are calculated in order to disincentivize UEs 115 in high mobility states from performing cell reselection, which may reduce the quantity and frequency of cell reselection procedures performed within the wireless communications system 100. By reducing the quantity and/or frequency of cell reselection procedures, techniques described herein may reduce control signaling overhead within the network, thereby improving resource utilization and increasing the reliability of wireless communications. Further, by reducing the quantity and/or frequency of cell reselection procedures, techniques described herein may reduce power consumption at the UEs 115 (e.g., by reducing power spent on cell reselection) and the network (e.g., by enabling serving cells to remain in NES states for longer periods of time).

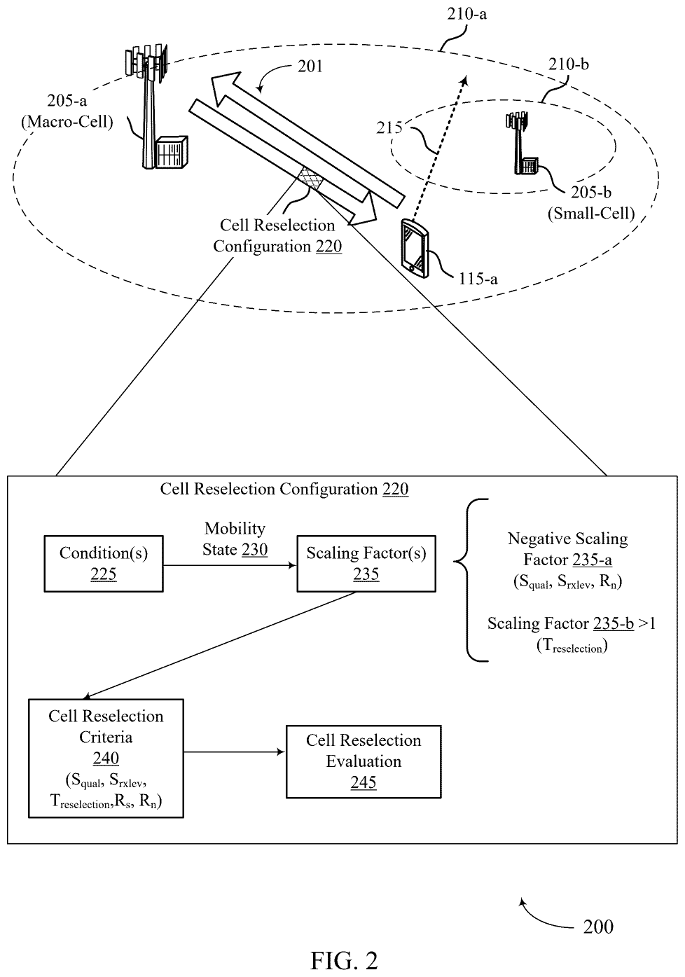

FIG. 2 shows an example of a wireless communications system 200 that supports techniques for speed-dependent cell reselection in accordance with one or more aspects of the present disclosure. In some examples, aspects of the wireless communications system 200 may implement, or be implemented by, aspects of the wireless communications system 100. In particular, the wireless communications system 200 may support cell reselection techniques that are based on a mobility state (e.g., speed) of a UE 115-a, as described herein.

The wireless communications system 200 may include a first serving cell 205-a, a second cell 205-b, and a UE 115-a. The cells 205 may be examples of primary cells (PCells), secondary cells (SCells), and the like, that facilitate wireless communications between the network and the UE 115-a. The first serving cell 205-a and the second cell 205-b may be associated with (e.g., supported by) one or more network entities 105. For example, as shown in FIG. 2, the first cell 205-a may be associated with (e.g., supported by) a first network entity 105, and the second cell 205-b may be associated with (e.g., supported by) a second network entity 105. In additional or alternative implementations, the first cell 205-a and the second cell 205-b may be associated with (e.g., supported by) the same network entity 105.

In some aspects, the cells 205 and the UE 115-a may communicate with one another using communication links 201, which may examples of NR or LTE links, sidelink (e.g., PC5 links), and the like, between the respective devices. In some cases, the communication links 201 may include examples of access links (e.g., Uu links) which may include bi-directional links that enable both uplink and downlink communication. For example, the UE 115-a may transmit uplink signals, such as uplink control signals or uplink data signals, to the first cell 205-a (e.g., to one or more components of a network entity 105 supporting the first cell 205-a) using the communication link 201, and the first cell 205-a (e.g., one or more components of the network entity 105 supporting the first cell 205-a) may transmit downlink signals, such as downlink control signals or downlink data signals, to the UE 115-a using the communication link 201.

As shown in FIG. 2, the cells 205 may be associated with respective coverage areas 210, where the cells 205 may be able to communicate with wireless devices (e.g., UEs 115) located within the respective coverage areas 210. For example, the first cell 205-a may be associated with a first coverage area 210-a, and the second cell 205-b may be associated with a second coverage area 210-b. In some cases, as shown in FIG. 2, the coverage areas 210 for multiple cells 205 may at least partially overlap. For instance, as shown in FIG. 2, the second cell 205-b (and the second coverage area 210-b) may be located wholly within the first coverage area 210-a of the first cell 205-a. In this regard, the first cell 205-a may be referred to as a “macro-cell,” and the second cell 205-b may be referred to as a “small-cell.” The network may exhibit an overlaid deployment of multiple small cells (e.g., multiple cells 205 positioned within the coverage area 210-a of the first cell 205-a).

In some aspects, the wireless communications system 200 may be configured to support or implement NES techniques to reduce a power consumption of the network. For example, in some cases, the second cell 205-b (e.g., small cell) may be configured to operate in a NES state, which may be an example of a low-power state or an idle/inactive state. While in the NES state, the second cell 205-b may not actively transmit signaling (to reduce power consumption), and may have to be “woken up” by wireless devices looking to connect with the second cell 205-b. For instance, while operating in the NES state, the second cell 205-b may not actively broadcast system information block (SIB) messages (e.g., SIB1, SIB2, etc.) and/or synchronization signal blocks (SSBs). Instead, wireless devices intending to connect with the second cell 205-b may transmit uplink wake-up signals (WUSs) to the second cell 205-b. In such cases, the uplink WUSs may “wake up” the second cell 205-b from the NES state so that the wireless devices can request more information or signaling that will be used to connect with the second cell 205-b (e.g., “on-demand” SIBs/SSBs).

However, as noted previously herein, some networks may utilize cell reselection procedures that reduce or minimize the potential energy-savings provided by NES techniques. For example, as described previously herein, UEs 115 may be configured to perform cell reselection procedures to switch between different cells 205 as the UEs 115 move throughout the network. When evaluating whether or not to perform a cell reselection procedure from one cell 205 to another, UEs 115 may perform measurements (e.g., RSRP, RSRQ) on signals received from the respective cells 205, and may therefore determine cell reselection criteria 240 that are used to determine whether or not the UEs 115 will perform cell reselection. The network may configure the UEs 115 with a cell reselection configuration 220 that defines how the UEs 115 are to calculate the cell reselection criteria 240.

In some networks, cell reselection configurations 220 are designed to incentivize cell reselection by reducing complexity and/or latency for UEs 115 to perform cell reselection (e.g., increase the probability/likelihood that the UEs 115-a can/will perform a cell reselection procedure, or otherwise), particularly for UEs 115 that are in a high mobility state. That is, for UEs 115 that are in a high mobility state, some cell reselection configurations reduce complexity for such UEs 115 to quickly and frequently move from one cell 205 to another.

For example, some networks may define mobility states of UEs 115 based on a quantity of cell reselection that the respective UEs 115 perform within some time period. That is, some cell reselection configurations 220 define conditions 225 for determining the mobility state 230 based on the quantity of cell reselections. For instance, if a UE 115 is in a high or medium mobility state 230, some networks define speed-dependent scaling rules for determining the mobility state 230, as outlined in Table 1 below:

TABLE 1
Legacy Speed-Dependent Cell Reselection Conditions

| Mobility State | Condition |
|---|---|
| Normal Mobility | # of cell reselections < NCR_M |
| | within TCRmax time period |
| Medium Mobility | # of cell reselections in range |
| | of (NCR_M:NCR_H) within |
| | TCRmax time period |
| High Mobility | # of cell reselections > NCR_H |
| | within TCRmax time period |

where TCRmax is in the range of 30 to 240 seconds, and where the NCR_M/NCR-H is within the range of 1 to 16.

When evaluating a cell reselection procedure (at cell reselection evaluation 245), UEs 115 may be configured to calculate cell reselection criteria 240 for the current cell 205 and the potential new cell 205 (e.g., neighboring cell 205) for intra-frequency and equal priority inter-frequency cells. For example, when evaluating a potential cell reselection procedure, the UE 115-a may be configured to calculate cell reselection criteria 240 Rₛ and Rₙ according to Equations 1 and 2 below:

$${R}_{s} = {Q}_{m e a s , s} + {Q}_{hyst} - {Q}_{offsettemp} \qquad ( 1 )$$

$${R}_{n} = {Q}_{m e a s , n} + {Q}_{o fset} - {Q}_{offsettemp} \qquad ( 2 )$$

where Rₛ and Rₙ indicate cell rankings for the current cell 205 (e.g., first cell 205-a) and the neighboring cell 205 (e.g., second cell 205-b), respectively, Q_{meas,s} and Q_{meas,n} indicate quality metrics associated with signals received from the current cell and the neighboring cell, respectively, Q_{hyst} is a hysteresis metric for the current cell 205, Q_{offset} defines an offset for cell reselection between two cells, and Q_{offsettemp} defines an offset value that is temporarily applied to target cells.

According to some previous cell reselection configurations 220, based on the determined mobility state 230 of a UE 115, the UE 115 is configured to apply a speed-dependent scaling rule. That is, the UE 115 is configured to add a scaling factor 235 to the parameter Q_{hyst} of the current cell 205 (e.g., first cell 205-a). According to previous cell reselection configurations 220, the scaling factor for Q_{hyst} may be less than or equal to 0 dB (e.g., scaling factor 235={−6 dB, −4 dB, −3 dB, 0 dB}). The usable values for the scaling factor 235 of the cell reselection configuration 220 may be configured by the network (e.g., broadcast to the UEs 115 via SIB2). The UE 115-a may be configured to use the determined/configured scaling factors 235 to determine cell reselection criteria 240, where the scaling factors 235 and cell reselection criteria 240 are used to determine/evaluate whether or not to perform a cell reselection procedure. In effect, by adding a negative scaling factor to Q_{hyst}, previous cell reselection configurations 220 effectively reduce the cell ranking Rₛ for the current serving cell 205 (as shown in Equation 1 above), thereby increasing a probability or likelihood that the UE 115 will perform a cell reselection procedure during the cell reselection evaluation 245.

Continuing with reference to previous cell reselection configurations 220, UEs 115 may be configured to adjust another cell reselection criteria 240 (T_{reselection}) in such a manner as to incentivize cell reselections. In particular, in some cases, a condition for reselecting a neighboring cell 205 (on a different frequency), is that the strength or quality of the neighboring cell 205 is higher than a threshold during a time period T_{reselection} (e.g., during a cell reselection timer). With some previous cell reselection configurations 220, UEs 115 may be configured to multiply the cell reselection criteria 240 T_{reselection} by a scaling factor 235 that is less than or equal to 1. The scaling factor 235 for T_{reselection} may be separately configured for different frequencies or frequency ranges. In some examples, the scaling factor may be 0.25, 0.5, 0.75, 1, or some other value within the range of 0 to 1. In some examples, T_{reselection} may be within a range of 0 to 7 seconds. By multiplying T_{reselection} by a scaling factor 235 that is less than 1, some cell reselection configurations effectively shorten the time period defined by T_{reselection}, again making it easier (and more likely) for the cell reselection criteria 240 for a cell reselection procedure to be satisfied (e.g., incentivizing cell reselection) during the cell reselection evaluation 245.

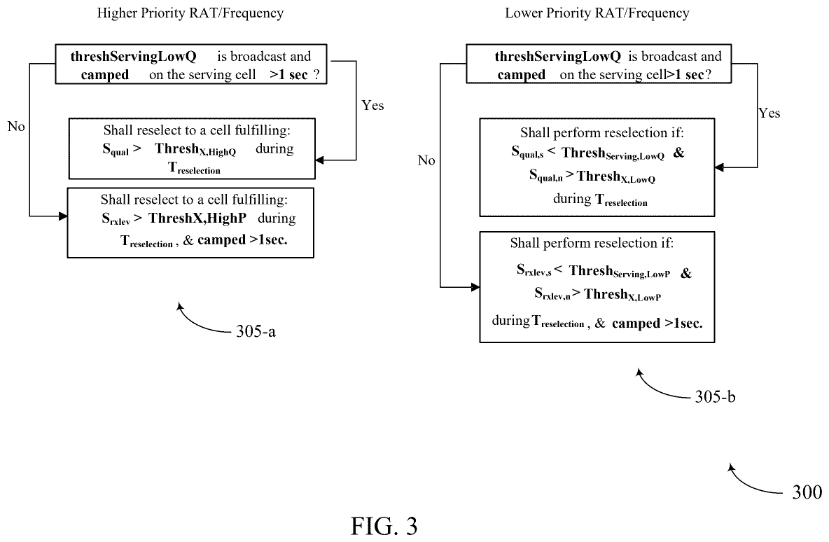

Examples of the cell reselection evaluation 245 are further shown and described in FIG. 3.

FIG. 3 shows an example of a cell reselection evaluation 300 that supports techniques for speed-dependent cell reselection in accordance with one or more aspects of the present disclosure. In some examples, aspects of the cell reselection evaluation 245 may implement, or be implemented by, aspects of the wireless communications system 100, the wireless communications system 200, or both. In particular, the cell reselection evaluation 300 illustrated in FIG. 3 may illustrate example evaluation processes 305-a, 305-b performed by the UE 115-a during the cell reselection evaluation 245 in FIG. 2.

The first evaluation processes 305-a illustrates example evaluation processes that may be performed by UEs 115 when evaluating whether or not to perform a cell reselection procedure from a current serving cell 205-a to a neighboring cell 205-b with a higher priority RAT/frequency. Comparatively, the second evaluation processes 305-b illustrates example evaluation processes that may be performed by UEs 115 when evaluating whether or not to perform a cell reselection procedure from a current serving cell 205-a to a neighboring cell 205-b with a lower priority RAT/frequency. As shown in FIG. 3, the evaluation processes 305 may utilize various cell reselection criteria 240, such as S_{qual} and Sᵣₓₗₑᵥ, which may be defined according to Equations 3 and 4 below:

$${S}_{rxlev} = {Q}_{rxlevmeas} - ( {Q}_{rxlevmin} + {Q}_{rxlevminoffset} ) - {P}_{compensation} - {Q}_{offsettemp} \qquad ( 3 )$$

$${S}_{qual} = {Q}_{qualmeas} - ( {Q}_{qualmin} + {Q}_{qualminoffset} ) - {Q}_{offsettemp} \qquad ( 4 )$$

where Sᵣₓₗₑᵥ is a cell reselection criterion 240 associated with an RSRP of the current serving cell (S_{rxlev,s}) and the neighboring cell (S_{rxlev,n}), S_{qual} is a cell reselection criterion 240 associated with an RSRQ of the current serving cell (S_{qual,s}) and the neighboring cell (S_{qual,n}), Qᵣₓₗₑᵥₘₑₐₛ defines the measured cell Rx level value (RSRP), Qᵣₓₗₑᵥₘᵢₙ defines the minimum Rx level in the cell (dBm), Q_{rxlevminoffset} defines an offset that is based on a periodic search for a higher priority PLMN, P_{compensation} defines a compensation value for the respective frequency range (e.g., FR1 or FR2), Q_{qualmeas} defines the measured cell quality value (RSRQ), Q_{qualmin} defines a minimum quality level in the cell (dB), and Q_{qualminoffset} defines an offset that is based on a periodic search for a higher priority PLMN.

When evaluating a cell reselection procedure to a neighboring cell 205 with the same frequency and/or same priority (e.g., for intra-frequency or equal-priority inter-frequency cell reselection), UEs 115 may be configured to select the cell 205 with the highest cell rank (e.g., select cell with higher Rₛ or Rₙ according to Equations 1 and 2) and which also meet Sᵣₓₗₑᵥ>0 and S_{qual}>0. In this regard, depending on the RAT, frequency, and/or priority of the neighboring cell, different cell reselection criteria 240 may be used, including Rₛ, Rₙ, Sᵣₓₗₑᵥ, S_{qual}, T_{reselection}, and other parameters (e.g., another configurable cell reselection criteria 240 based on the number of SSBs: rangeToBestCell).

As outlined above, some cell reselection configurations use speed-dependent (e.g., mobility state-dependent) rules/conditions 225 for calculating scaling factors 235 in such a manner as to make execution of cell reselection easier/faster in the case of high and medium mobility states (e.g., incentivize or otherwise increase triggering of cell reselection). In particular, some cell reselection configurations utilize scaling factors 235 for calculating/adjusting cell reselection criteria 240 to incentivize cell reselection. However, such cell reselection configurations that incentivize UEs 115 to perform cell reselections may result in several drawbacks. For example, such cell reselection configurations may result in increased control signaling and/or additional power consumption at the UEs 115 and the network. For example, cell reselection configurations that incentivize UEs 115 to perform cell reselection may increase the quantity of cell reselections within the network, thereby increasing control signaling and network congestion.

Moreover, it may not always be advantageous for UEs 115 to perform cell reselection. For example, referring to FIG. 2, the UE 115-a may be moving quickly (e.g., high mobility state) along a trajectory 215 while operating in an idle or inactive operational state (e.g., RRC_IDLE, RRC_INACTIVE). In such cases, it may not be advantageous for the UE 115-a to perform cell reselection from the first serving cell 205-a to the second cell 205-b, despite the fact that the trajectory 215 will go through the coverage area 210-b of the second cell 205-b and the fact that the second cell 205-b may be able to provide higher quality communications as compared to the first serving cell 205-a for some time period. In particular, due to the high mobility state of the UE 115-a and the small coverage area 210-b of the second cell 205-b, the UE 115-a may quickly move out of range of the second cell 205-b, and may therefore have to perform another cell reselection procedure to switch back to the first cell 205-a or another small cell 205. Additionally, because the UE 15-a does not need to perform communications while in the idle/inactive state, it may be sufficient for the UE 115-a to remain connected to the first serving cell 205-a, even if the second cell 205-b may provide higher quality service or communications for a short period of time.

In this example, performing a cell reselection from the first serving cell 205-a to the second cell 205-b may not offer much benefit, and may actually result in increased control signaling and power consumption at the network and the UE 115-a. In particular, in cases where the second cell 205-b is operating in a NES state, forcing the UE 115-a to perform a cell reselection procedure may unnecessarily “wake up” the second cell 205-b from the NES state (thereby increasing network power consumption) despite the fact that the UE 115-a may only be connected to the second cell 205-b for a short period of time.

In other words, in cases where the UE 115-a is moving fast and is expected to remain in an idle/inactive state, it may be preferred (from energy efficiency point of view) for the UE 115-a to continue camping on the first cell 205-a (e.g., macro-cell), and therefore refrain from reselecting the second cell 205-b (e.g., refrain from performing a cell reselection procedure to the small-cell). Otherwise, if the UE 115-a is moving slowly (e.g., lower mobility state), and/or if the UE 115-a does not expect to continue operating in the idle/inactive state (e.g., if the UE 115-a expects to data traffic), then it may be preferred for the UE 115-a to select the second cell 205-b (small-cell) for camping and/or establishing a connection.

Accordingly, some aspects of the present disclosure are directed to new cell reselection configurations that are intended to disincentivize cell reselection procedures at UEs when the mobility states of the UEs satisfy (e.g., exceed) some threshold. That is, some aspects of the present disclosure are directed to cell reselection configurations 220 that make cell reselection of small-cells (e.g., second cell 205-b) harder/slower, particularly in the case of high and medium mobility states.

In particular, aspects of the present disclosure are directed to a cell reselection configuration 220 that uses a cell-specific and speed-dependent negative scaling factor 235-a for calculating (e.g., that is added to) one or more of the cell reselection criteria 240 S_{qual}, Sᵣₓₗₑᵥ, and Rₙ of the neighbor cell 205-b and/or the current serving cell 205-a (where the scaling factors 235 and cell reselection criteria 240 are used to determine/evaluate whether or not to perform a cell reselection procedure). Additionally, or alternatively, the cell reselection configuration 220 of the present disclosure may utilize a cell-specific and speed dependent scaling factor 235-b that is greater than 0 for calculating (e.g., that is multiplied to) T_{reselection}. The respective scaling factors 235-a, 235-b may be cell-specific in that they may be configured/evaluated for respective cells (e.g., small cells, or only for overlaid NES cells).

For example, as shown in FIG. 2 the first cell 205-a may be configured the UE 115-a with a cell reselection configuration 220 (e.g., via RRC signaling, system information signaling, SIB1, etc.). As described previously herein, the cell reselection configuration 220 may be associated with or define a set of conditions 225 that are used to determine the mobility state 230 of the UE 115. Based on the mobility state 230, and in accordance with the cell reselection configuration 220, the UE 115 may be configured to determine scaling factors 235-a, 235-b that will be used to calculate/determine cell reselection criteria 240, where the cell reselection criteria 240 are used during the cell reselection evaluation 245 to determine whether or not the UE 115-a will perform a cell reselection from the first cell 205-a to the second cell 205-b (e.g., scaling factors 235 and cell reselection criteria 240 are used to perform cell reselection evaluation 245).

As compared to previous cell reselection configurations, which are used to incentivize cell reselection, the cell reselection configuration 220 of the present disclosure may be configured to disincentivize cell reselection by making it slower or more difficult (e.g., less likely/probable) for the UE 115-a to perform cell reselection. For instance, as described previously herein, when calculating Rₛ according to Equation 1, some previous cell reselection configurations may utilize a scaling factor 235 that is less than 0 for Q_{hyst}, effectively reducing Rₛ for the current cell 205 and making it more likely/probable that the UE 115 will perform a cell reselection procedure. Comparatively, the cell reselection configuration 220 described herein may utilize a negative scaling factor 235-a for calculating Rₙ according to Equation 2 above, effectively reducing Rₙ for the neighbor cell 205 and making it less likely/probable that the UE 115 will perform a cell reselection procedure.

By way of another example, as described previously herein, when calculating T_{reselection} according to previous cell reselection configurations 220, UEs 115 may be configured to multiply T_{reselection} by a scaling factor 235 that is less than or equal to 1, effectively shortening the time period defined by T_{reselection} and making it easier (and more likely) for the UE 115 to perform cell reselection. Comparatively, the cell reselection configuration 220 described herein may multiply T_{reselection} by a scaling factor 235-b that is greater than 1, effectively lengthening the time period defined by T_{reselection} and making it harder (and less likely) for the UE 115 to perform cell reselection. In a similar manner, additional or alternative scaling factors 235 may be used to calculate additional or alternative cell reselection criteria 240 in a manner that reduces triggering of cell reselection (e.g., disincentivizes cell reselection).

In some implementations, some or all the overlaid small cells (e.g., second cell 205-b) of the wireless communications system 200 may be configured to be on the same frequency, where a common scaling factor 235 for T_{reselection} (e.g., scaling factor 235-b) may be configured for all or subsets of the overlaid small cells (where the range of values for the scaling factor 235-b may be greater than 1, as described herein).

The cell reselection configuration 220 described herein that utilizes the scaling factors 235-a, 235-b may be used to better tailor cell reselection procedures performed by a UE 115 to the mobility state of the UE 115 to strike a balance between power savings at the UE 115 and network, and a quality of communications at the UE 115. For example, if the UE 115-a is expected to remain in idle/inactive state, and/or if the UE 115-a is moving fast (e.g., high mobility state 230), the cell reselection configuration 220 described herein may enable the UE 115-a to keep camping on the macro-cell (e.g., first cell 205-a), and refrain from performing a cell reselection procedure to the small cell (e.g., second cell 205-b).

However, in additional or alternative cases, the UE 115-a may exhibit a need to be connected soon, and may therefore need to become connected to a NES cell. In this regard, in some implementations, the UE 115-a may be configured with multiple cell reselection configurations 220. For example, in some cases, the UE 115-a may be configured with the new cell reselection configuration 220 described herein with the scaling factors 235-a, 235-b (which is configured to incentivize cell reselection), as well as a “legacy” cell reselection configuration 220 (which is configured to disincentivize cell reselection). In such cases, it may be up to UE 115-a implementation as to which cell reselection configuration 220 is to be used. That is, the network (and applicable specifications or standards) may leave it to the UE 115-a by indicating that the UE 115-a “may” apply the new cell reselection configuration 220 described herein with the speed-dependent scaling factor 235 rules for cell reselection (instead of indicating that the UE 115-a “shall” use the new cell reselection configuration 220). To better balance NES and UE 115 impacts, the network may indicate that the UE 115-a “shall” use the new cell reselection configuration 220 described herein when the UE 115-a is in a high mobility state 230, and that the UE 115-a “may” use the new cell reselection configuration 220 described herein when the UE 115-a is in a medium, normal, or low mobility state 230.

In other cases where the UE 115-a is configured with multiple cell reselection configurations 220, the network may define (and/or the UE 115-a may be pre-configured with) more specific rules as to when the UE 115-a is to use the new cell reselection configuration 220 described herein (and/or when the UE 115-a is to use the “legacy” cell reselection configuration 220). For example, in cases where the UE 115-a is expected to transition to the connected state, the UE 115-a may be configured to ignore the new cell reselection configuration 220 that disincentivizes cell reselection described herein (and instead use a “legacy” cell reselection configuration 220 that incentivizes cell reselection).

In other cases where the UE 115-a is configured with multiple cell reselection configurations 220, the network may explicitly indicate which cell reselection configuration 220 is to be used (such as via paging redirections). For example, if the network pages the UE 115-a to indicate that there is data waiting to be delivered to the UE 115-a (e.g., transmits a paging redirection message), the UE 115-a may be configured to ignore the new cell reselection configuration 220 described herein and instead use the “legacy” cell reselection configuration 220 that incentivizes cell reselection in order to enable the UE 115-a to connect to the second cell 205-b quicker to receive the data traffic. Similarly, paging messages may include specific indications that are used to indicate which cell reselection configuration 220 the UE 115-a is expected or allowed to use (e.g., “reselection allowed” indications).

In yet other cases, the UE 115-a may select which cell reselection configuration 220 to use based on a priority or quality of service (QoS) metric of communication to be performed by the UE 115-a. That is, for UE/uplink-initiated connection establishment, there can be rules for selecting a cell reselection configuration that will be used depending on the cause or QoS requirement of the uplink traffic, predicted amount of uplink traffic at the UE 115, a load or resource utilization, an energy cost at the UE 115 and/or the network, or any combination thereof. For instance, if the UE 115-a has high priority traffic (and/or traffic with a high QoS requirements), the UE 115-a may select to use a cell reselection configuration 220 that incentivizes cell reselection so that the UE 115-a can perform a cell reselection procedure to the second cell 205-b to communicate the traffic with the high priority/high QoS requirements.

Additional or alternative aspects of the present disclosure are directed to new conditions 225 that are used to evaluate mobility states 230 at the UE 115-a. In other words, some aspects of the present disclosure are directed to configurations and techniques that redefine how the mobility state 230 of the UE 115-a is calculated. In particular, as described herein and outlined in Table 1 above, some networks define mobility state 230 based on the number of cell reselections the UE 115-a performs in some time period (e.g., TCRmax time period). In other words, some networks use a quantity of cell reselections as a condition 225 for determining/defining mobility state 230. However, such conditions 225 may not serve some situations. For example, the UE 115-a may camp on the macro cell (e.g., first cell 205-a) for a long time, but may still be moving quickly and therefore have high mobility. In such cases, the conditions 225 of previous cell reselection configurations 220 may still define such a UE 115 as having a low mobility state (due to the low number of cell reselections in a time period).

Accordingly, aspects of the present disclosure are directed to new conditions 225 for determining a mobility state 230 based on (1) the actual speed/velocity of the UE, or (2) the rate or amount of change of measurements performed by the UE (e.g., rate/magnitude of change of RSRP measurements may be used as a proxy for speed and mobility state). That is, the conditions 225 for determining/defining mobility state 230 may be separated from the quantity of cell reselections.

For instance, the cell reselection configuration 220 of the present disclosure may be associated with conditions 225 for calculating mobility state 230, where the mobility state 230 is defined/determined based on the rate or amount of change of measurements (e.g., RSRP, RSRQ, S_{qual}, Sᵣₓₗₑᵥ) of the current cell 205-a, a neighboring cell (e.g., target small-cell), or a combination of the serving cell 205-a and one or more neighboring cells. In other words, according to the cell reselection configuration 220 defined herein, the UE 115-a may be configured to determine a mobility state of the UE 115-a based on how much, or how quickly, measurements performed on signals received from the first cell 205-a change over time. That is, the rate and/or magnitude of changes in RSRP/RSRQ measurements performed on signals received from the first cell 205-a may be used as a proxy for speed and mobility state 230.

In some cases, the network may configure various thresholds that are used to evaluate the rate/magnitude of measurement changes for determining the mobility state 230 of the UE 115-a. For example, the UE 115-a may perform measurements (e.g., RSRP, RSRQ, S_{qual}, Sᵣₓₗₑᵥ) for signals received from the first serving cell 205-a, as represented by Meas current, and may compare Meas_{current} to some reference value Refₘₑₐₛ. The UE 115-a may compare the result to one or more thresholds (e.g., Thresh₁, Thresh₂) configured by the network to determine the mobility state 230 of the UE 115-a. For instance, if Thresh₁<|Meas_{current}−Refₘₑₐₛ|<Thresh₂, then the UE 115-a may determine that the UE 115-a is in a medium mobility state 230. Comparatively, if |Meas_{current}−Refₘₑₐₛ|>Thresh₂, then the UE 115-a may determine that the UE 115-a is in a high mobility state 230. In this regard, these thresholds and equations may be examples of the conditions 225 of the cell reselection configuration 220 for determining mobility state 230. In some cases, these conditions 225 (e.g., equations, thresholds) may need to be valid or satisfied for a configured period of time for the UE 115-a to determine the applicable mobility state 230.

In some aspects, the respective parameters for evaluating the mobility state 230 of the UE 115, such as thresholds (e.g., Thresh₁, Thresh₂) and timers, may be defined commonly across multiple cells, defined in a cell-specific manner, in a frequency-specific manner, or defined separately for the current serving cell 205-a relative to neighboring cells 205 (e.g., one value/threshold for current serving cell 205-a, another value/threshold for neighboring cells 205). When considering multiple cells 205, the UE 115-a may need to check individual conditions for different cells 205 and determine the mobility state 230 of the UE 115-a based on the result of one (or multiple) conditions (e.g., mobility state 230 may be determined based on measurements performed on signals satisfying thresholds configured for one or multiple cells). For instance, the UE 115 may determine the mobility state 230 of the UE 115-a as long as some conditions are met for one or for all or for X % of cells 205. Otherwise, the UE 115-a may use a cell 205 with highest or lowest associated calculated metric, such as amount of variation in measured signal strength/quality, to determine the mobility state 230 of the UE 115-a. Additionally, or alternatively, some joint conditions may be defined for multiple cells 205. In such cases, to calculate the metric, such as the amount of variation in measured signal strength/quality, the UE 115-a may consider multiple cells 205 and their associated measurements to calculate a common metric, and use the common metric to determine the mobility state 230.

Techniques described herein may be used to better tailor cell reselection procedures performed by the UE 115-a to the mobility state 230 of the UE 115-a to strike a balance between power savings at the UE 115-a and network, and a quality of communications at the UE 115-a. In particular, the cell reselection configuration 220 described herein may adjust how scaling factors 235 and cell reselection criteria 240 are calculated in order to disincentivize the UE 115-a in a high mobility state 230 from performing cell reselection, which may reduce the quantity and frequency of cell reselection procedures performed within the wireless communications system 200. By reducing the quantity and/or frequency of cell reselection procedures, techniques described herein may reduce control signaling overhead within the network, thereby improving resource utilization and increasing the reliability of wireless communications. Further, by reducing the quantity and/or frequency of cell reselection procedures, techniques described herein may reduce power consumption at the UE 115-a (e.g., by reducing power spent on cell reselection) and the network (e.g., by enabling serving cells to remain in NES states for longer periods of time).

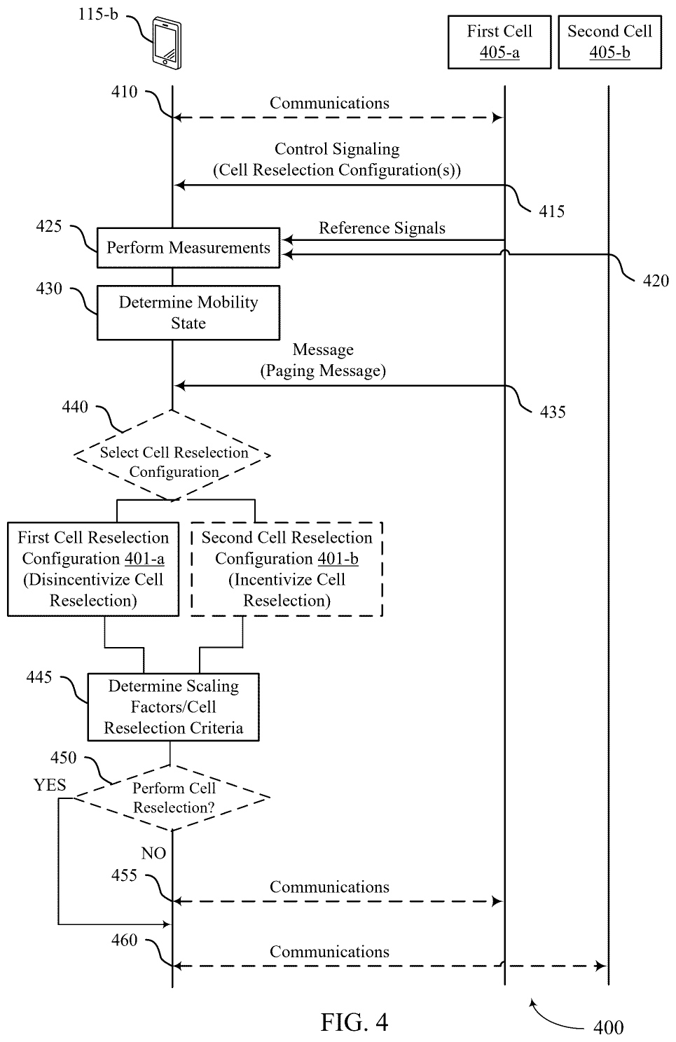

FIG. 4 shows an example of a process flow 400 that supports techniques for speed-dependent cell reselection in accordance with one or more aspects of the present disclosure. In some examples, aspects of the process flow 400 may implement, or be implemented by, aspects of the wireless communications system 100, the wireless communications system 200, the cell reselection evaluation 300, or any combination thereof. In particular, the process flow 400 illustrates cell reselection techniques that are based on a mobility state (e.g., speed) of a UE 115-b, as described herein.

The process flow 400 includes a UE 115-b, a first cell 405-a, and a second cell 405-b, which may be examples of wireless devices as described herein. For example, the UE 115-b, the first cell 405-a, and the second cell 405-b illustrated in FIG. 4 may include examples of the UE 115-a, the first cell 205-a, and the second cell 205-b, respectively, as illustrated in FIG. 2. In this regard, the first cell 405-a may be an example of a macro cell, and the second cell 405-b may be an example of a small cell (e.g., a small cell in a NES state). As described previously herein, the first cell 405-a and the second cell 405-b may be associated with (e.g., supported by) the same or different network entities.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 410, the UE 115-b may communicate with the first cell 405-a. In other words, the UE 115-b may be connected to the first cell 405-a and may be “camped” on the first cell 405-a.

At signaling operation 415, the UE 115-b may receive control signaling that indicates one or more cell reselection configurations that are usable by the UE 115-b for evaluating cell reselection procedures. The control signaling may include RRC signaling, system information signaling (e.g., SIB1, SIB2), or both.

For example, as shown in FIG. 4, the control signaling may configure the UE 115-b with a first cell reselection configuration 401-a and a second cell reselection configuration 401-b. In this example, the first cell reselection configuration 401-a may be configured to reduce triggering of (e.g., disincentivize) cell reselection procedures at the UE 115-b, and the second cell reselection configuration 401-b may be configured to increase triggering of (e.g., incentivize) cell reselection procedures at the UE 115-b. In this regard, the first cell reselection configuration 401-a may be an example of the “new” cell reselection configuration 220 described herein, and the second cell reselection configuration 401-b may be an example of a “legacy” cell reselection configuration used by some networks. The respective cell reselection configurations 401 may include respective sets of conditions 225 for evaluating mobility states 230 of the UE 115-b, as well as different sets of scaling factors 235 for determining/calculating cell reselection criteria 240.

At signaling operation 420, the UE 115-b may receive reference signals from the first cell 405-a, the second cell 405-b, or both. The reference signals may include SSBs, CSI-RSs, or both.

At measurement operation 425, the UE 115-b may perform measurements on the received reference signals. the measurements may include RSRP, RSRQ, CSI, SNR, SINR, CQI, and the like. In some aspects, the UE 115-b may be configured to use the measurements performed at measurement operation 425 in order to evaluate a potential cell reselection procedure from the first cell 405-a to the second cell 405-b.

At operation 430, the UE 115-b may determine a mobility state of the UE 115-b. The UE 115-b may determine the mobility state of the UE 115-b based on the control signaling received at signaling operation 410. In other words, the control signaling may indicate a set of conditions 225 that are usable for determining the mobility state 230. In other cases, each respective cell reselection configuration 401 may include a respective set of conditions 225 that are usable for determining the mobility state 230. In such cases, the UE 115-b may not determine the mobility state of the UE 115-b until after the UE 115-b has selected which cell reselection configuration 401 to use at operation 440.

According to some aspects of the present disclosure, in some cases, the UE 115-b may determine the mobility state of the UE 115-b based on (1) the actual speed/velocity of the UE 115-b, or (2) the rate or amount of change of measurements performed by the UE 115-b (e.g., rate/magnitude of change of RSRP measurements for the first cell 405-a at measurement operation 425 may be used as a proxy for speed and mobility state).

At signaling operation 435, the UE 115-b may receive a message from the first cell 405-a. In some cases, the message may include information that is used to determine which cell reselection configuration 401 is to be used by the UE 115-b. For example, in some cases, the message may explicitly indicate which cell reselection configuration 401 is to be used. In other cases, the message may indicate rules or conditions (e.g., network conditions, data priorities, etc.) that are used by the UE 115-b to select which cell reselection configuration 401 is to be used. Additionally, or alternatively, such information the enables the UE 115-b to select a cell reselection configuration 401 may be indicated via the control signaling at signaling operation 415.

At operation 440, the UE 115-b may select which cell reselection configuration 401 is to be used. The UE 115-b may select a cell reselection configuration 401 at operation 440 based on receiving the control signaling at signaling operation 415, determining the mobility state of the UE 115-b at operation 430, receiving the message at signaling operation 430, or any combination thereof. For example, in cases where the UE 115-b is in a high mobility state and an idle/inactive state, the UE 115-b may select to use the first cell reselection configuration 401-a. By way of another example, in cases where the paging message at signaling operation 435 indicates that there is data traffic waiting to be delivered to the UE 115-b, the UE 115-b may select to use the second cell reselection configuration 401-b that incentivizes cell reselections to enable the UE 115-b to quickly connect to the second cell 405-b to receive the data.

In particular, as described previously herein, the first cell reselection configuration 401-a may be configured to disincentivize cell reselection at the UE 115-b (e.g., make it slower/harder, or less probable/likely) that the UE 115-b will perform a cell reselection procedure. Comparatively, the second cell reselection configuration 401-b may be configured to incentivize cell reselection at the UE 115-b (e.g., make it faster/easier, or more probable/likely) that the UE 115-b will perform a cell reselection procedure.

At operation 445, the UE 115-b may determine scaling factors and cell reselection criteria that will be used to evaluate whether or not to perform a cell reselection procedure. As noted previously herein, the way/manner that scaling factors and cell reselection criteria are determined may be based on which cell reselection configuration 401 is selected at operation 440.

For instance, as described herein, if the UE 115-b selects the first cell reselection configuration 401-a at operation 440, the UE 115-b may determine/use a negative scaling factor 235-a for calculating Rₙ according to Equation 2 above, effectively reducing Rₙ for the neighbor cell 405 and making it less likely/probable that the UE 115 will perform a cell reselection procedure. By way of another example, if the UE 115-b selects the first cell reselection configuration 401-a at operation 440, the UE 115-b may determine/use a scaling factor 235-b that is greater than 1 for calculating/modifying T_{reselection}, effectively lengthening the time period defined by T_{reselection} and making it harder (and less likely) for the UE 115-b to perform cell reselection.

At operation 450, the UE 115-b may determine whether or not to perform a cell reselection procedure from the first cell 405-a to the second cell 405-b. The decision made at operation 445 may be based on the measurements performed at operation 425, the mobility state determined at operation 430, which cell reselection configuration 401 was selected at operation 440, the scaling factors/cell selection criteria determined at operation 445, or any combination thereof. For example, the UE 115-b may use the scaling factors/cell reselection criteria determined at operation 445 to perform the analyses shown using the evaluation processes 305 shown and described with respect to FIG. 3.

If the UE 115-b does not perform a cell reselection procedure at operation 450 (e.g., operation 450=NO), the process flow 400 may proceed to signaling operation 455. Comparatively, if the UE 115-b does perform a cell reselection procedure at 450 (e.g., operation 450=YES), the process flow 400 may proceed to signaling operation 460.

At signaling operation 455, the UE 115-b may communicate with the first cell 405-a. That is, the UE 115-b may remain camped on the first cell 405-a based on refraining from performing a cell reselection procedure at operation 450.

At signaling operation 460, the UE 115-b may communicate with the second cell 405-b based on performing a cell reselection procedure at operation 450. That is, the UE 115-b may perform a cell reselection procedure to switch from the first cell 405-a to the second cell 405-b. As part of the cell reselection procedure, the respective devices/entities (e.g., UE 115-b, first cell 405-a, second cell 405-b) may exchange signaling/information that enables a handover from the first cell 405-a to the second cell 405-b. For example, the first cell 405-a may transmit data traffic to the second cell 405-b so that the second cell 405-b can deliver the data traffic to the UE 115-b following a completion of the second cell 405-b.

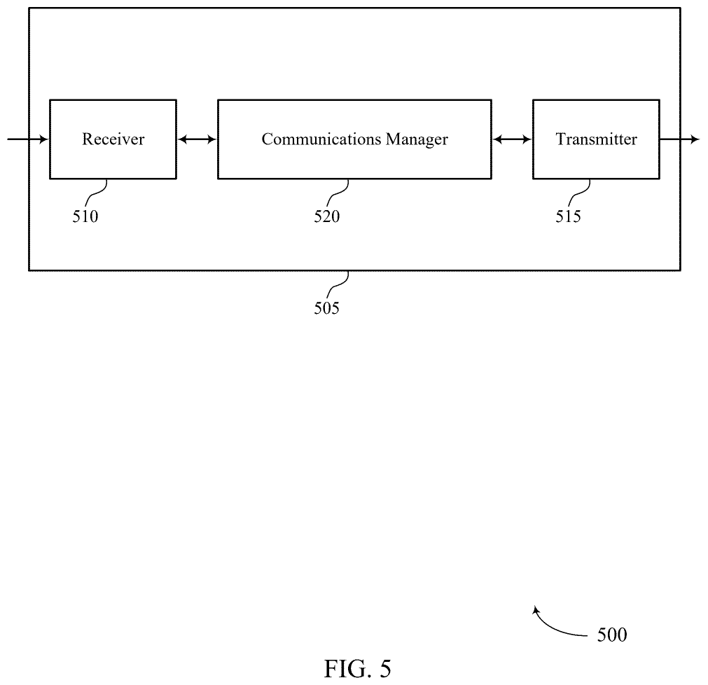

FIG. 5 shows a block diagram 500 of a device 505 that supports techniques for speed-dependent cell reselection in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for speed-dependent cell reselection). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for speed-dependent cell reselection). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for speed-dependent cell reselection as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 is capable of, configured to, or operable to support a means for receiving, from a first cell, control signaling indicating a cell reselection configuration to disincentivize cell reselection procedures at the UE based on a mobility state of the UE satisfying a threshold mobility state, the cell reselection configuration including a set of conditions for determining one or more scaling factors based on the mobility state of the UE, the one or more scaling factors usable for evaluating cell reselection procedures at the UE. The communications manager 520 is capable of, configured to, or operable to support a means for performing measurements on signals received from a second cell. The communications manager 520 is capable of, configured to, or operable to support a means for performing, or refraining from performing, a cell reselection procedure from the first cell to the second cell based on the measurements and the one or more scaling factors of the cell reselection configuration, where the one or more scaling factors are determined based on the mobility state of the UE. The communications manager 520 is capable of, configured to, or operable to support a means for communicating with the first cell based on refraining from performing the cell reselection procedure, or with the second cell based on performing the cell reselection procedure.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques that may be used to better tailor cell reselection procedures performed by a UE 115 to the mobility state of the UE 115 to strike a balance between power savings at the UE 115 and network, and a quality of communications at the UE 115. In particular, a new cell reselection procedure may adjust how scaling factors and cell reselection criteria are calculated in order to disincentivize UEs 115 in high mobility states from performing cell reselection, which may reduce the quantity and frequency of cell reselection procedures performed within the wireless communications system 100. By reducing the quantity and/or frequency of cell reselection procedures, techniques described herein may reduce control signaling overhead within the network, thereby improving resource utilization and increasing the reliability of wireless communications. Further, by reducing the quantity and/or frequency of cell reselection procedures, techniques described herein may reduce power consumption at the UEs 115 (e.g., by reducing power spent on cell reselection) and the network (e.g., by enabling serving cells to remain in NES states for longer periods of time).

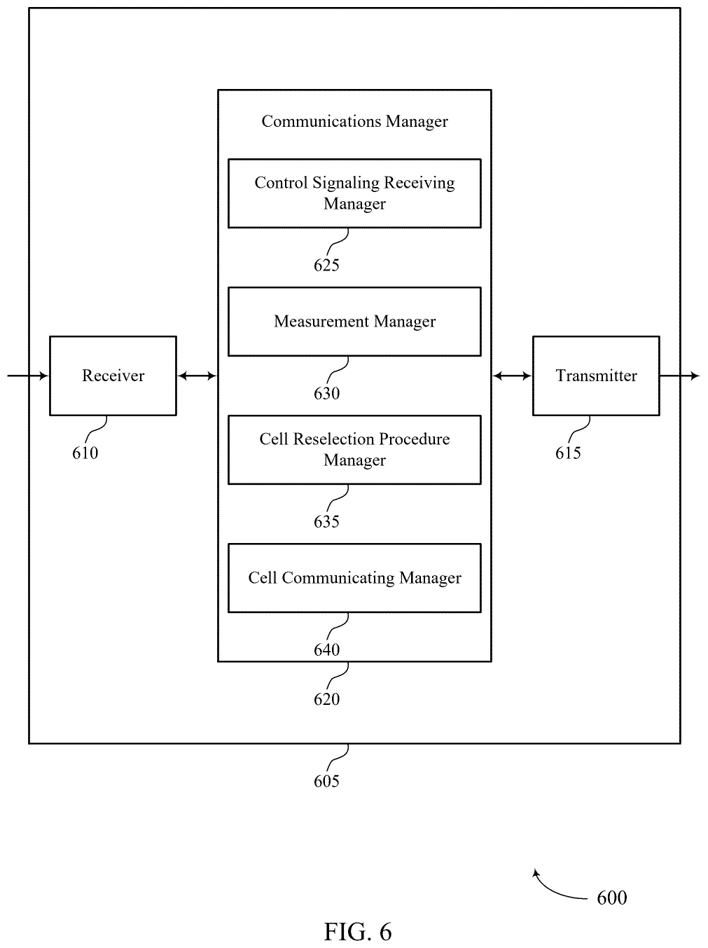

FIG. 6 shows a block diagram 600 of a device 605 that supports techniques for speed-dependent cell reselection in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for speed-dependent cell reselection). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for speed-dependent cell reselection). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for speed-dependent cell reselection as described herein. For example, the communications manager 620 may include a control signaling receiving manager 625, a measurement manager 630, a cell reselection procedure manager 635, a cell communicating manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The control signaling receiving manager 625 is capable of, configured to, or operable to support a means for receiving, from a first cell, control signaling indicating a cell reselection configuration to disincentivize cell reselection procedures at the UE based on a mobility state of the UE satisfying a threshold mobility state, the cell reselection configuration including a set of conditions for determining one or more scaling factors based on the mobility state of the UE, the one or more scaling factors usable for evaluating cell reselection procedures at the UE. The measurement manager 630 is capable of, configured to, or operable to support a means for performing measurements on signals received from a second cell. The cell reselection procedure manager 635 is capable of, configured to, or operable to support a means for performing, or refraining from performing, a cell reselection procedure from the first cell to the second cell based on the measurements and the one or more scaling factors of the cell reselection configuration, where the one or more scaling factors are determined based on the mobility state of the UE. The cell communicating manager 640 is capable of, configured to, or operable to support a means for communicating with the first cell based on refraining from performing the cell reselection procedure, or with the second cell based on performing the cell reselection procedure.

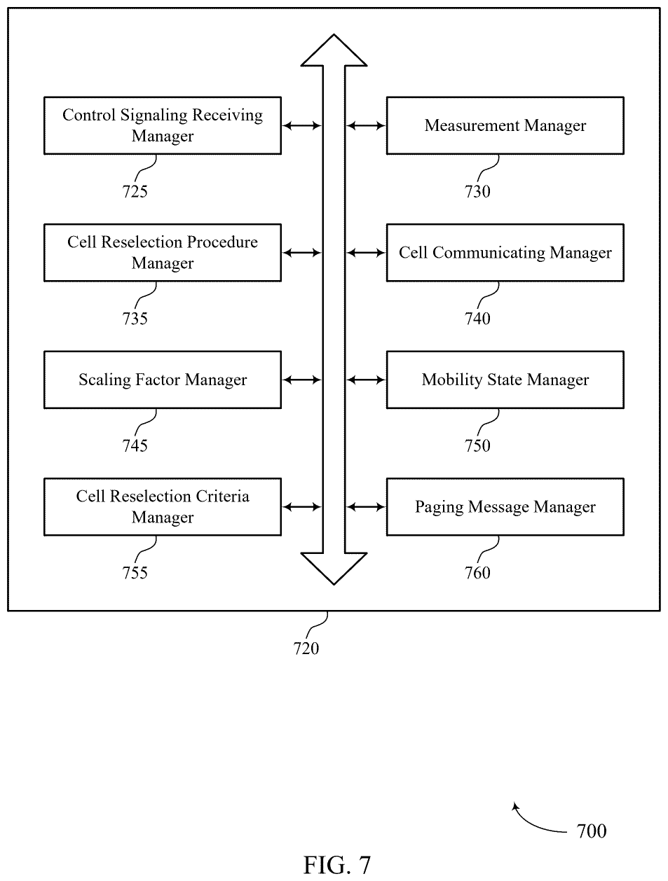

FIG. 7 shows a block diagram 700 of a communications manager 720 that supports techniques for speed-dependent cell reselection in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for speed-dependent cell reselection as described herein. For example, the communications manager 720 may include a control signaling receiving manager 725, a measurement manager 730, a cell reselection procedure manager 735, a cell communicating manager 740, a scaling factor manager 745, a mobility state manager 750, a cell reselection criteria manager 755, a paging message manager 760, or any combination thereof. Each of these components, or components or subcomponents thereof (e.g., one or more processors, one or more memories), may communicate, directly or indirectly, with one another (e.g., via one or more buses).

The control signaling receiving manager 725 is capable of, configured to, or operable to support a means for receiving, from a first cell, control signaling indicating a cell reselection configuration to disincentivize cell reselection procedures at the UE based on a mobility state of the UE satisfying a threshold mobility state, the cell reselection configuration including a set of conditions for determining one or more scaling factors based on the mobility state of the UE, the one or more scaling factors usable for evaluating cell reselection procedures at the UE. The measurement manager 730 is capable of, configured to, or operable to support a means for performing measurements on signals received from a second cell. The cell reselection procedure manager 735 is capable of, configured to, or operable to support a means for performing, or refraining from performing, a cell reselection procedure from the first cell to the second cell based on the measurements and the one or more scaling factors of the cell reselection configuration, where the one or more scaling factors are determined based on the mobility state of the UE. The cell communicating manager 740 is capable of, configured to, or operable to support a means for communicating with the first cell based on refraining from performing the cell reselection procedure, or with the second cell based on performing the cell reselection procedure.

In some examples, the scaling factor manager 745 is capable of, configured to, or operable to support a means for determining a negative scaling factor for calculating the cell signal strength metric, the cell signal quality metric, the cell ranking metric, or any combination thereof, in accordance with the set of conditions and based on the mobility state of the UE, where refraining from performing the cell reselection procedure is based on the negative scaling factor.

In some examples, the scaling factor manager 745 is capable of, configured to, or operable to support a means for determining a scaling factor that is greater than one for calculating the cell reselection timer in accordance with the set of conditions and based on the mobility state of the UE, where refraining from performing the cell reselection procedure is based on the scaling factor that is greater than one.

In some examples, the measurement manager 730 is capable of, configured to, or operable to support a means for performing additional measurements on signals received from the first cell. In some examples, the mobility state manager 750 is capable of, configured to, or operable to support a means for determining the mobility state of the UE based on a comparison between the additional measurements and the one or more thresholds, where the one or more scaling factors are based on the mobility state.

In some examples, the one or more thresholds are associated with a rate of change, a magnitude of change, or both, of the additional measurements performed on the signals received from the first cell.

In some examples, the cell reselection criteria manager 755 is capable of, configured to, or operable to support a means for determining one or more cell reselection criteria for evaluating the cell reselection procedure based on the one or more scaling factors, the one or more cell reselection criteria including a cell signal strength metric or a cell signal quality metric associated with the first cell, the second cell, or both, a cell reselection timer associated with an evaluation of the cell reselection procedure, a cell ranking metric associated with the first cell or the second cell, or any combination thereof.

In some examples, the control signaling receiving manager 725 is capable of, configured to, or operable to support a means for receiving a second cell reselection configuration to incentivize cell reselection procedures at the UE based on the mobility state of the UE, the second cell reselection configuration including a second set of conditions for determining the one or more scaling factors based on the mobility state of the UE, where performance, or lack of performance, of the cell reselection procedure is based on the cell reselection configuration or the second cell reselection configuration.

In some examples, the cell reselection procedure manager 735 is capable of, configured to, or operable to support a means for selecting one of the cell reselection configuration or the second cell reselection configuration based on the mobility state of the UE satisfying one or more mobility state thresholds, where performance, or lack of performance, of the cell reselection procedure is based on the selecting.

In some examples, the paging message manager 760 is capable of, configured to, or operable to support a means for receiving a paging message from the first cell, where selecting one of the cell reselection configuration or the second cell reselection configuration is based on the paging message.

In some examples, selecting one of the cell reselection configuration or the second cell reselection configuration is based on a priority, a QoS, or both, associated with communications to be performed by the UE.

In some examples, the UE is configured to refrain from performing the cell reselection procedure based on the mobility state of the UE exceeding the threshold mobility state, and based on the UE operating in an idle operational state or an inactive operational state.

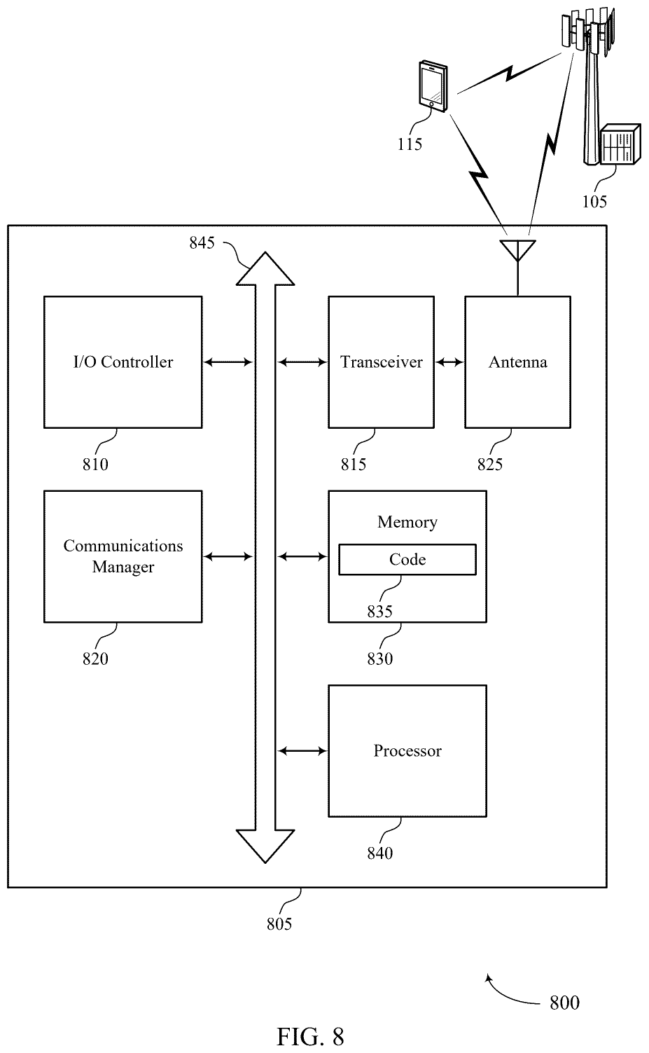

FIG. 8 shows a diagram of a system 800 including a device 805 that supports techniques for speed-dependent cell reselection in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for speed-dependent cell reselection). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

For example, the communications manager 820 is capable of, configured to, or operable to support a means for receiving, from a first cell, control signaling indicating a cell reselection configuration to disincentivize cell reselection procedures at the UE based on a mobility state of the UE satisfying a threshold mobility state, the cell reselection configuration including a set of conditions for determining one or more scaling factors based on the mobility state of the UE, the one or more scaling factors usable for evaluating cell reselection procedures at the UE. The communications manager 820 is capable of, configured to, or operable to support a means for performing measurements on signals received from a second cell. The communications manager 820 is capable of, configured to, or operable to support a means for performing, or refraining from performing, a cell reselection procedure from the first cell to the second cell based on the measurements and the one or more scaling factors of the cell reselection configuration, where the one or more scaling factors are determined based on the mobility state of the UE. The communications manager 820 is capable of, configured to, or operable to support a means for communicating with the first cell based on refraining from performing the cell reselection procedure, or with the second cell based on performing the cell reselection procedure.

By including or configuring the communications manager 820 in accordance with examples as described herein, the device 805 may support techniques that may be used to better tailor cell reselection procedures performed by a UE 115 to the mobility state of the UE 115 to strike a balance between power savings at the UE 115 and network, and a quality of communications at the UE 115. In particular, a new cell reselection procedure may adjust how scaling factors and cell reselection criteria are calculated in order to disincentivize UEs 115 in high mobility states from performing cell reselection, which may reduce the quantity and frequency of cell reselection procedures performed within the wireless communications system 100. By reducing the quantity and/or frequency of cell reselection procedures, techniques described herein may reduce control signaling overhead within the network, thereby improving resource utilization and increasing the reliability of wireless communications. Further, by reducing the quantity and/or frequency of cell reselection procedures, techniques described herein may reduce power consumption at the UEs 115 (e.g., by reducing power spent on cell reselection) and the network (e.g., by enabling serving cells to remain in NES states for longer periods of time).

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for speed-dependent cell reselection as described herein, or the at least one processor 840 and the at least one memory 830 may be otherwise configured to, individually or collectively, perform or support such operations.

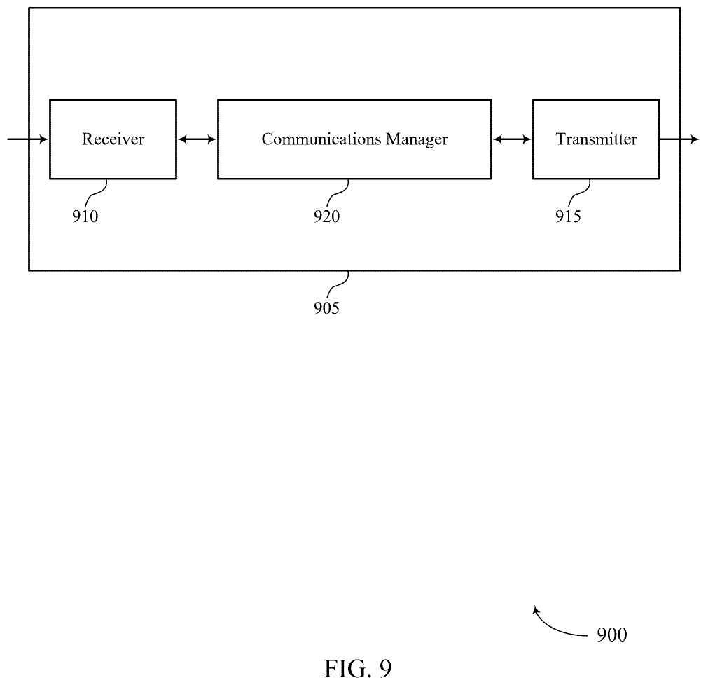

FIG. 9 shows a block diagram 900 of a device 905 that supports techniques for speed-dependent cell reselection in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for speed-dependent cell reselection as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for transmitting, to a UE, control signaling indicating a cell reselection configuration to disincentivize cell reselection procedures at the UE based on a mobility state of the UE satisfying a threshold mobility state, the cell reselection configuration including a set of conditions for determining one or more scaling factors based on the mobility state of the UE, the one or more scaling factors usable for evaluating cell reselection procedures at the UE. The communications manager 920 is capable of, configured to, or operable to support a means for performing, or refraining from performing, a cell reselection procedure for the UE from the first cell to a second cell based on the one or more scaling factors of the cell reselection configuration, where the one or more scaling factors are based on the mobility state of the UE.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques that may be used to better tailor cell reselection procedures performed by a UE 115 to the mobility state of the UE 115 to strike a balance between power savings at the UE 115 and network, and a quality of communications at the UE 115. In particular, a new cell reselection procedure may adjust how scaling factors and cell reselection criteria are calculated in order to disincentivize UEs 115 in high mobility states from performing cell reselection, which may reduce the quantity and frequency of cell reselection procedures performed within the wireless communications system 100. By reducing the quantity and/or frequency of cell reselection procedures, techniques described herein may reduce control signaling overhead within the network, thereby improving resource utilization and increasing the reliability of wireless communications. Further, by reducing the quantity and/or frequency of cell reselection procedures, techniques described herein may reduce power consumption at the UEs 115 (e.g., by reducing power spent on cell reselection) and the network (e.g., by enabling serving cells to remain in NES states for longer periods of time).

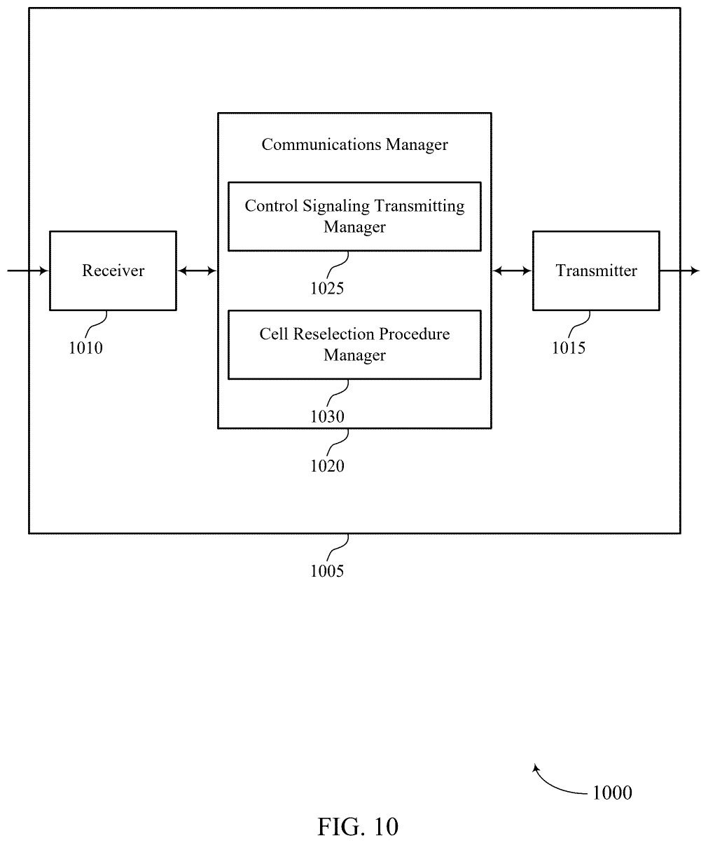

FIG. 10 shows a block diagram 1000 of a device 1005 that supports techniques for speed-dependent cell reselection in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for speed-dependent cell reselection as described herein. For example, the communications manager 1020 may include a control signaling transmitting manager 1025 a cell reselection procedure manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The control signaling transmitting manager 1025 is capable of, configured to, or operable to support a means for transmitting, to a UE, control signaling indicating a cell reselection configuration to disincentivize cell reselection procedures at the UE based on a mobility state of the UE satisfying a threshold mobility state, the cell reselection configuration including a set of conditions for determining one or more scaling factors based on the mobility state of the UE, the one or more scaling factors usable for evaluating cell reselection procedures at the UE. The cell reselection procedure manager 1030 is capable of, configured to, or operable to support a means for performing, or refraining from performing, a cell reselection procedure for the UE from the first cell to a second cell based on the one or more scaling factors of the cell reselection configuration, where the one or more scaling factors are based on the mobility state of the UE.

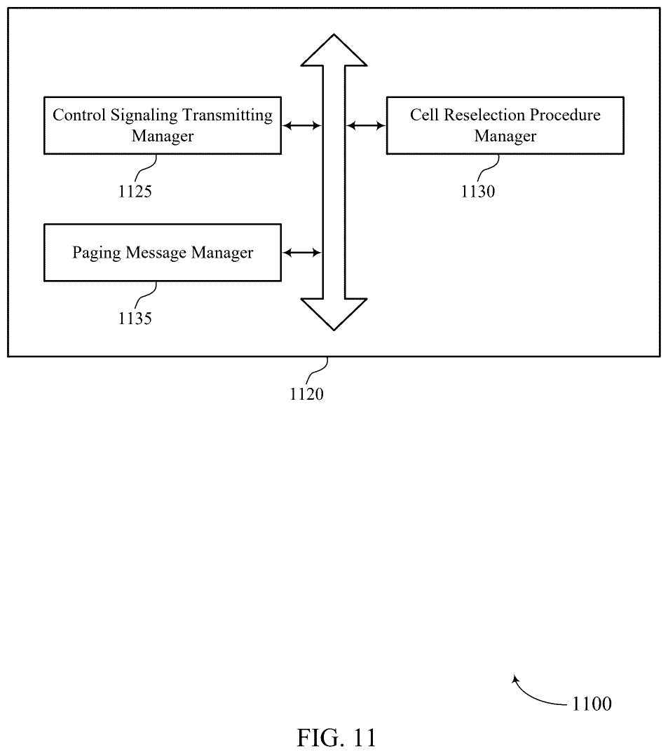

FIG. 11 shows a block diagram 1100 of a communications manager 1120 that supports techniques for speed-dependent cell reselection in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for speed-dependent cell reselection as described herein. For example, the communications manager 1120 may include a control signaling transmitting manager 1125, a cell reselection procedure manager 1130, a paging message manager 1135, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The control signaling transmitting manager 1125 is capable of, configured to, or operable to support a means for transmitting, to a UE, control signaling indicating a cell reselection configuration to disincentivize cell reselection procedures at the UE based on a mobility state of the UE satisfying a threshold mobility state, the cell reselection configuration including a set of conditions for determining one or more scaling factors based on the mobility state of the UE, the one or more scaling factors usable for evaluating cell reselection procedures at the UE. The cell reselection procedure manager 1130 is capable of, configured to, or operable to support a means for performing, or refraining from performing, a cell reselection procedure for the UE from the first cell to a second cell based on the one or more scaling factors of the cell reselection configuration, where the one or more scaling factors are based on the mobility state of the UE.

In some examples, set of conditions for determining the one or more scaling factors include one or more thresholds for evaluating the mobility state of the UE. In some examples, the one or more thresholds are associated with a rate of change, a magnitude of change, or both, of measurements performed by the UE on signals received from the first cell.

In some examples, the one or more scaling factors are usable for determining one or more cell reselection criteria for evaluating the cell reselection procedure, the one or more cell reselection criteria including a cell signal strength metric or a cell signal quality metric associated with the first cell, the second cell, or both, a cell reselection timer associated with an evaluation of the cell reselection procedure, a cell ranking metric associated with the first cell or the second cell, or any combination thereof.

In some examples, the control signaling transmitting manager 1125 is capable of, configured to, or operable to support a means for transmitting, to the UE, a second cell reselection configuration to incentivize cell reselection procedures at the UE based on the mobility state of the UE, the second cell reselection configuration including a second set of conditions for determining the one or more scaling factors based on the mobility state of the UE, where performance, or lack of performance, of the cell reselection procedure is based on the cell reselection configuration or the second cell reselection configuration.

In some examples, the paging message manager 1135 is capable of, configured to, or operable to support a means for transmitting, to the UE, a paging message including information for selecting one of the cell reselection configuration or the second cell reselection configuration, where performance, or lack of performance, of the cell reselection procedure is based on the paging message.

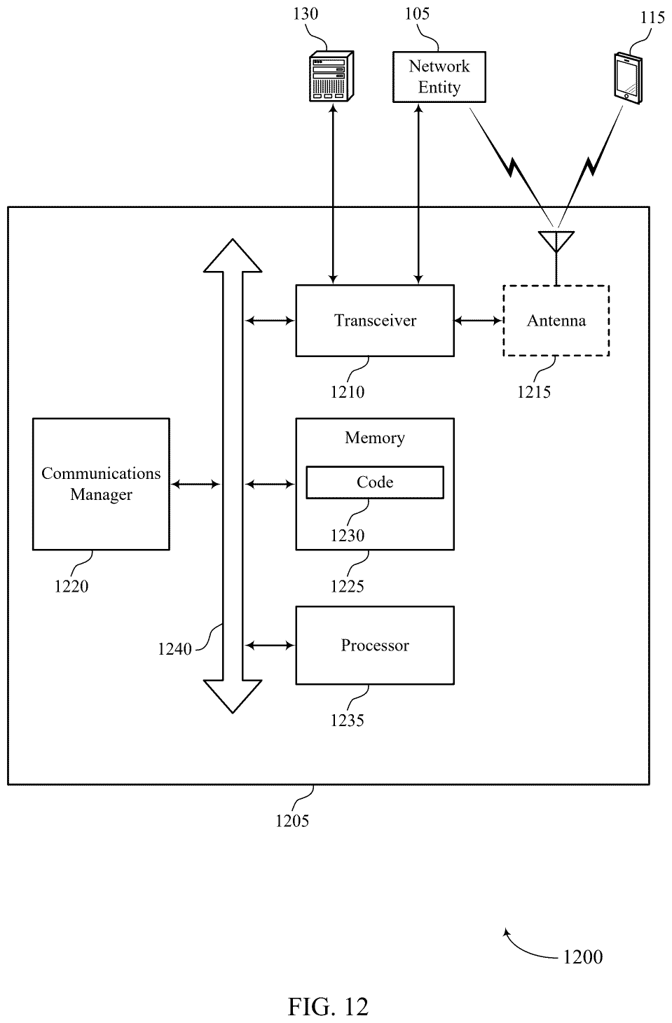

FIG. 12 shows a diagram of a system 1200 including a device 1205 that supports techniques for speed-dependent cell reselection in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for speed-dependent cell reselection). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

For example, the communications manager 1220 is capable of, configured to, or operable to support a means for transmitting, to a UE, control signaling indicating a cell reselection configuration to disincentivize cell reselection procedures at the UE based on a mobility state of the UE satisfying a threshold mobility state, the cell reselection configuration including a set of conditions for determining one or more scaling factors based on the mobility state of the UE, the one or more scaling factors usable for evaluating cell reselection procedures at the UE. The communications manager 1220 is capable of, configured to, or operable to support a means for performing, or refraining from performing, a cell reselection procedure for the UE from the first cell to a second cell based on the one or more scaling factors of the cell reselection configuration, where the one or more scaling factors are based on the mobility state of the UE.

By including or configuring the communications manager 1220 in accordance with examples as described herein, the device 1205 may support techniques that may be used to better tailor cell reselection procedures performed by a UE 115 to the mobility state of the UE 115 to strike a balance between power savings at the UE 115 and network, and a quality of communications at the UE 115. In particular, a new cell reselection procedure may adjust how scaling factors and cell reselection criteria are calculated in order to disincentivize UEs 115 in high mobility states from performing cell reselection, which may reduce the quantity and frequency of cell reselection procedures performed within the wireless communications system 100. By reducing the quantity and/or frequency of cell reselection procedures, techniques described herein may reduce control signaling overhead within the network, thereby improving resource utilization and increasing the reliability of wireless communications. Further, by reducing the quantity and/or frequency of cell reselection procedures, techniques described herein may reduce power consumption at the UEs 115 (e.g., by reducing power spent on cell reselection) and the network (e.g., by enabling serving cells to remain in NES states for longer periods of time).

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for speed-dependent cell reselection as described herein, or the at least one processor 1235 and the at least one memory 1225 may be otherwise configured to, individually or collectively, perform or support such operations.

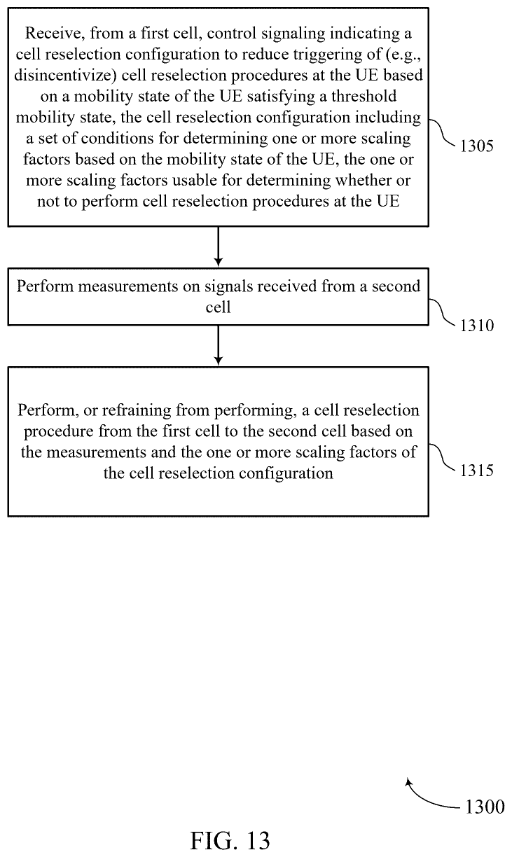

FIG. 13 shows a flowchart illustrating a method 1300 that supports techniques for speed-dependent cell reselection in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a first cell, control signaling indicating a cell reselection configuration to reduce triggering of (e.g., disincentivize) cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE. The operations of 1305 may be performed in accordance with examples as disclosed herein. In some examples, aspects of the operations of 1305 may be performed by a control signaling receiving manager 725 as described with reference to FIG. 7.

At 1310, the method may include performing measurements on signals received from a second cell. The operations of 1310 may be performed in accordance with examples as disclosed herein. In some examples, aspects of the operations of 1310 may be performed by a measurement manager 730 as described with reference to FIG. 7.

At 1315, the method may include performing, or refraining from performing, a cell reselection procedure from the first cell to the second cell based on the measurements and the one or more scaling factors of the cell reselection configuration. The operations of 1315 may be performed in accordance with examples as disclosed herein. In some examples, aspects of the operations of 1315 may be performed by a cell reselection procedure manager 735 as described with reference to FIG. 7.

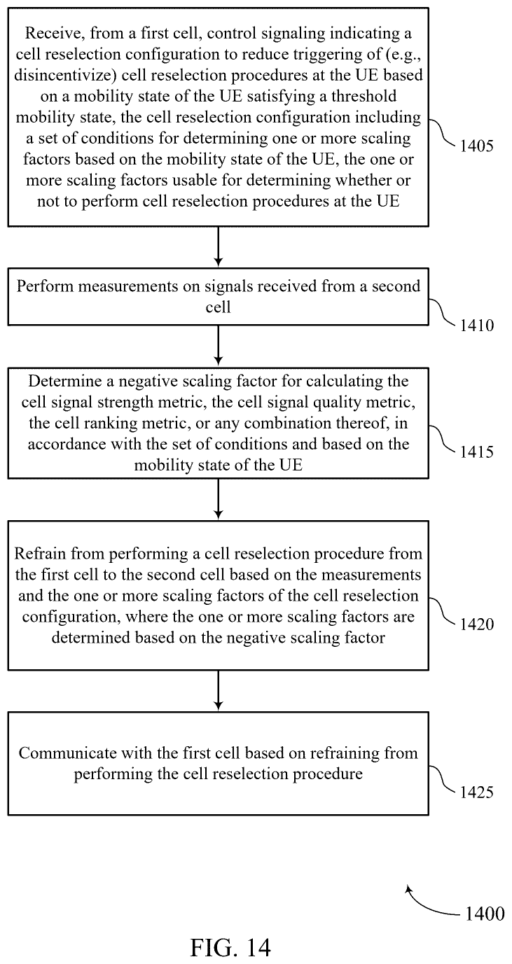

FIG. 14 shows a flowchart illustrating a method 1400 that supports techniques for speed-dependent cell reselection in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a first cell, control signaling indicating a cell reselection configuration to reduce triggering of (e.g., disincentivize) cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE. The operations of 1405 may be performed in accordance with examples as disclosed herein. In some examples, aspects of the operations of 1405 may be performed by a control signaling receiving manager 725 as described with reference to FIG. 7.

At 1410, the method may include performing measurements on signals received from a second cell. The operations of 1410 may be performed in accordance with examples as disclosed herein. In some examples, aspects of the operations of 1410 may be performed by a measurement manager 730 as described with reference to FIG. 7.

At 1415, the method may include determining a negative scaling factor for calculating the cell signal strength metric, the cell signal quality metric, the cell ranking metric, or any combination thereof, in accordance with the set of conditions and based on the mobility state of the UE. The operations of 1415 may be performed in accordance with examples as disclosed herein. In some examples, aspects of the operations of 1415 may be performed by a scaling factor manager 745 as described with reference to FIG. 7.

At 1420, the method may include refraining from performing a cell reselection procedure from the first cell to the second cell based on the measurements and the one or more scaling factors of the cell reselection configuration, where the one or more scaling factors are determined based on the negative scaling factor. The operations of 1420 may be performed in accordance with examples as disclosed herein. In some examples, aspects of the operations of 1420 may be performed by a cell reselection procedure manager 735 as described with reference to FIG. 7.

At 1425, the method may include communicating with the first cell based on refraining from performing the cell reselection procedure. The operations of 1425 may be performed in accordance with examples as disclosed herein. In some examples, aspects of the operations of 1425 may be performed by a cell communicating manager 740 as described with reference to FIG. 7.

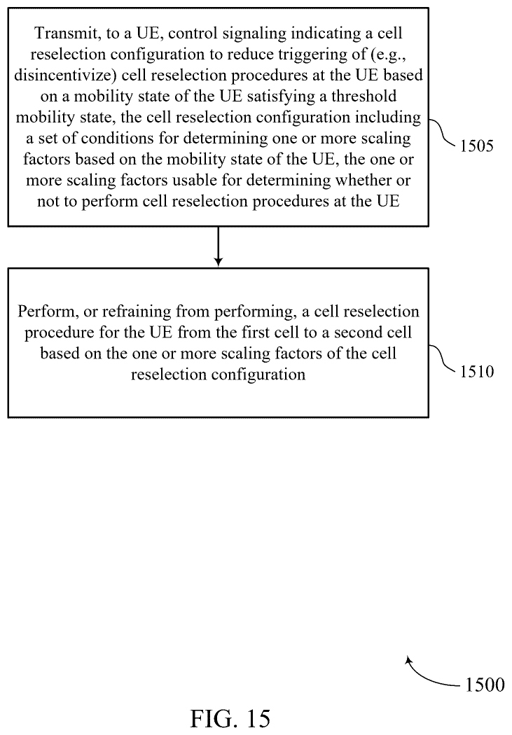

FIG. 15 shows a flowchart illustrating a method 1500 that supports techniques for speed-dependent cell reselection in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, control signaling indicating a cell reselection configuration to reduce triggering of (e.g., disincentivize) cell reselection procedures at the UE based on a mobility state of the UE satisfying a threshold mobility state, the cell reselection configuration including a set of conditions for determining one or more scaling factors based on the mobility state of the UE, the one or more scaling factors usable for determining whether or not to perform cell reselection procedures at the UE. The operations of 1505 may be performed in accordance with examples as disclosed herein. In some examples, aspects of the operations of 1505 may be performed by a control signaling transmitting manager 1125 as described with reference to FIG. 11.

At 1510, the method may include performing, or refraining from performing, a cell reselection procedure for the UE from the first cell to a second cell based on the one or more scaling factors of the cell reselection configuration. The operations of 1510 may be performed in accordance with examples as disclosed herein. In some examples, aspects of the operations of 1510 may be performed by a cell reselection procedure manager 1130 as described with reference to FIG. 11.

The following provides an overview of aspects of the present disclosure:
Aspect 1: A method for wireless communications at a UE, comprising: receiving, from a first cell, control signaling indicating a cell reselection configuration to reduce triggering of cell reselection procedures at the UE based at least in part on a mobility state of the UE satisfying a threshold mobility state, the cell reselection configuration comprising a set of conditions for determining one or more scaling factors based at least in part on the mobility state of the UE, the one or more scaling factors usable for determining whether or not to perform cell reselection procedures at the UE; performing measurements on signals received from a second cell; and performing, or refraining from performing, a cell reselection procedure from the first cell to the second cell based at least in part on the measurements and the one or more scaling factors of the cell reselection configuration.
Aspect 2: The method of aspect 1, wherein the one or more scaling factors are usable for calculating one or more cell reselection criteria, the one or more cell reselection criteria comprising a cell signal strength metric, a cell signal quality metric, a cell ranking metric, or any combination thereof, associated with the second cell, the method further comprising: determining a negative scaling factor for calculating the cell signal strength metric, the cell signal quality metric, the cell ranking metric, or any combination thereof, in accordance with the set of conditions and based at least in part on the mobility state of the UE, wherein refraining from performing the cell reselection procedure is based at least in part on the negative scaling factor.
Aspect 3: The method of any of aspects 1 through 2, wherein the one or more scaling factors are usable for calculating one or more cell reselection criteria, wherein the one or more cell reselection criteria comprise a cell reselection timer associated with an evaluation of the cell reselection procedure, the method further comprising: determining a scaling factor that is greater than one for calculating the cell reselection timer in accordance with the set of conditions and based at least in part on the mobility state of the UE, wherein refraining from performing the cell reselection procedure is based at least in part on the scaling factor that is greater than one.
Aspect 4: The method of any of aspects 1 through 3, wherein set of conditions for determining the one or more scaling factors comprise one or more thresholds for evaluating the mobility state of the UE, the method further comprising: performing additional measurements on signals received from the first cell; and determining the mobility state of the UE based at least in part on a comparison between the additional measurements and the one or more thresholds.
Aspect 5: The method of aspect 4, wherein the one or more thresholds are associated with a rate of change, a magnitude of change, or both, of the additional measurements performed on the signals received from the first cell.
Aspect 6: The method of any of aspects 1 through 5, further comprising: determining one or more cell reselection criteria based at least in part on the one or more scaling factors, the one or more cell reselection criteria comprising a cell signal strength metric or a cell signal quality metric associated with the first cell, the second cell, or both, a cell reselection timer associated with an evaluation of the cell reselection procedure, a cell ranking metric associated with the first cell or the second cell, or any combination thereof.
Aspect 7: The method of any of aspects 1 through 6, further comprising: receiving a second cell reselection configuration to increase triggering of cell reselection procedures at the UE based at least in part on the mobility state of the UE, the second cell reselection configuration comprising a second set of conditions for determining the one or more scaling factors based at least in part on the mobility state of the UE, wherein performance, or lack of performance, of the cell reselection procedure is based at least in part on the cell reselection configuration or the second cell reselection configuration.
Aspect 8: The method of aspect 7, further comprising: selecting one of the cell reselection configuration or the second cell reselection configuration based at least in part on the mobility state of the UE satisfying one or more mobility state thresholds, wherein performance, or lack of performance, of the cell reselection procedure is based at least in part on the selecting.
Aspect 9: The method of aspect 8, further comprising: receiving a paging message from the first cell, wherein selecting one of the cell reselection configuration or the second cell reselection configuration is based at least in part on the paging message.
Aspect 10: The method of any of aspects 8 through 9, wherein selecting one of the cell reselection configuration or the second cell reselection configuration is based at least in part on a priority, a quality of service, or both, associated with communications to be performed by the UE.
Aspect 11: The method of any of aspects 1 through 10, wherein the UE is configured to refrain from performing the cell reselection procedure based at least in part on the mobility state of the UE exceeding the threshold mobility state, and based at least in part on the UE operating in an idle operational state or an inactive operational state.
Aspect 12: The method of any of aspects 1 through 11, further comprising: communicating with the first cell based at least in part on refraining from performing the cell reselection procedure; or communicating with the second cell based at least in part on performing the cell reselection procedure.
Aspect 13: A method for wireless communications at a first cell, comprising: transmitting, to a UE, control signaling indicating a cell reselection configuration to reduce triggering of cell reselection procedures at the UE based at least in part on a mobility state of the UE satisfying a threshold mobility state, the cell reselection configuration comprising a set of conditions for determining one or more scaling factors based at least in part on the mobility state of the UE, the one or more scaling factors usable for determining whether or not to perform cell reselection procedures at the UE; and performing, or refraining from performing, a cell reselection procedure for the UE from the first cell to a second cell based at least in part on the one or more scaling factors of the cell reselection configuration.
Aspect 14: The method of aspect 13, wherein set of conditions for determining the one or more scaling factors comprise one or more thresholds for evaluating the mobility state of the UE, the one or more thresholds are associated with a rate of change, a magnitude of change, or both, of measurements performed by the UE on signals received from the first cell.
Aspect 15: The method of any of aspects 13 through 14, wherein the one or more scaling factors are usable for determining one or more cell reselection criteria for evaluating the cell reselection procedure, the one or more cell reselection criteria comprising a cell signal strength metric or a cell signal quality metric associated with the first cell, the second cell, or both, a cell reselection timer associated with an evaluation of the cell reselection procedure, a cell ranking metric associated with the first cell or the second cell, or any combination thereof.
Aspect 16: The method of any of aspects 13 through 15, further comprising: transmitting, to the UE, a second cell reselection configuration to increase triggering of cell reselection procedures at the UE based at least in part on the mobility state of the UE, the second cell reselection configuration comprising a second set of conditions for determining the one or more scaling factors based at least in part on the mobility state of the UE, wherein performance, or lack of performance, of the cell reselection procedure is based at least in part on the cell reselection configuration or the second cell reselection configuration.
Aspect 17: The method of aspect 16, further comprising: transmitting, to the UE, a paging message comprising information for selecting one of the cell reselection configuration or the second cell reselection configuration, wherein performance, or lack of performance, of the cell reselection procedure is based at least in part on the paging message.
Aspect 18: A UE comprising one or more memories storing processor-executable code, and one or more processors coupled with the one or more memories and individually or collectively operable to execute the code to cause the UE to perform a method of any of aspects 1 through 12.
Aspect 19: A UE comprising at least one means for performing a method of any of aspects 1 through 12.
Aspect 20: A non-transitory computer-readable medium storing code the code comprising instructions executable by one or more processors to perform a method of any of aspects 1 through 12.
Aspect 21: A first cell comprising one or more memories storing processor-executable code, and one or more processors coupled with the one or more memories and individually or collectively operable to execute the code to cause the first cell to perform a method of any of aspects 13 through 17.
Aspect 22: A first cell comprising at least one means for performing a method of any of aspects 13 through 17.
Aspect 23: A non-transitory computer-readable medium storing code the code comprising instructions executable by one or more processors to perform a method of any of aspects 13 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a first cell, control signaling that indicates a cell reselection configuration to reduce triggering of cell reselection procedures at the UE based at least in part on a mobility state of the UE satisfying a threshold mobility state, the cell reselection configuration comprising a set of conditions to determine one or more scaling factors based at least in part on the mobility state of the UE, the one or more scaling factors usable to determine whether or not to perform cell reselection procedures at the UE;
perform measurements on signals received from a second cell; and
perform, or refrain from performing, a cell reselection procedure from the first cell to the second cell based at least in part on the measurements and the one or more scaling factors of the cell reselection configuration.

2. The UE of claim 1, wherein the one or more scaling factors are usable to calculate one or more cell reselection criteria, the one or more cell reselection criteria comprising a cell signal strength metric, a cell signal quality metric, a cell ranking metric, or any combination thereof, associated with the second cell, wherein the one or more processors are individually or collectively further operable to execute the code to cause the UE to:
determine a negative scaling factor for calculating the cell signal strength metric, the cell signal quality metric, the cell ranking metric, or any combination thereof, in accordance with the set of conditions and based at least in part on the mobility state of the UE, wherein refraining from performing the cell reselection procedure is based at least in part on the negative scaling factor.

3. The UE of claim 1, wherein the one or more scaling factors are usable to calculate one or more cell reselection criteria, wherein the one or more cell reselection criteria comprise a cell reselection timer associated with an evaluation of the cell reselection procedure, wherein the one or more processors are individually or collectively further operable to execute the code to cause the UE to:
determine a scaling factor that is greater than one to calculate the cell reselection timer in accordance with the set of conditions and based at least in part on the mobility state of the UE, wherein refraining from performing the cell reselection procedure is based at least in part on the scaling factor that is greater than one.

4. The UE of claim 1, wherein the set of conditions for determining the one or more scaling factors comprise one or more thresholds for evaluating the mobility state of the UE, wherein the one or more processors are individually or collectively further operable to execute the code to cause the UE to:
perform additional measurements on signals received from the first cell; and
determine the mobility state of the UE based at least in part on a comparison between the additional measurements and the one or more thresholds.

5. The UE of claim 4, wherein the one or more thresholds are associated with a rate of change, a magnitude of change, or both, of the additional measurements performed on the signals received from the first cell.

6. The UE of claim 1, wherein the one or more processors are individually or collectively further operable to execute the code to cause the UE to:
determine one or more cell reselection criteria based at least in part on the one or more scaling factors, the one or more cell reselection criteria comprising a cell signal strength metric or a cell signal quality metric associated with the first cell, the second cell, or both, a cell reselection timer associated with an evaluation of the cell reselection procedure, a cell ranking metric associated with the first cell or the second cell, or any combination thereof.

7. The UE of claim 1, wherein the one or more processors are individually or collectively further operable to execute the code to cause the UE to:
receive a second cell reselection configuration to increase triggering of cell reselection procedures at the UE based at least in part on the mobility state of the UE, the second cell reselection configuration comprising a second set of conditions to determine the one or more scaling factors based at least in part on the mobility state of the UE, wherein performance, or lack of performance, of the cell reselection procedure is based at least in part on the cell reselection configuration or the second cell reselection configuration.

8. The UE of claim 7, wherein the one or more processors are individually or collectively further operable to execute the code to cause the UE to:
select one of the cell reselection configuration or the second cell reselection configuration based at least in part on the mobility state of the UE satisfying one or more mobility state thresholds, wherein performance, or lack of performance, of the cell reselection procedure is based at least in part on the selecting.

9. The UE of claim 8, wherein the one or more processors are individually or collectively further operable to execute the code to cause the UE to:
receive a paging message from the first cell, wherein the selection of one of the cell reselection configuration or the second cell reselection configuration is based at least in part on the paging message.

10. The UE of claim 8, wherein the selection of one of the cell reselection configuration or the second cell reselection configuration is based at least in part on a priority, a quality of service, or both, associated with communications to be performed by the UE.

11. The UE of claim 1, wherein the UE is configured to refrain from performing the cell reselection procedure based at least in part on the mobility state of the UE exceeding the threshold mobility state, and based at least in part on the UE operating in an idle operational state or an inactive operational state.

12. The UE of claim 1, wherein the one or more processors are individually or collectively further operable to execute the code to cause the UE to:
communicate with the first cell based at least in part on refraining from performing the cell reselection procedure; or
communicate with the second cell based at least in part on performing the cell reselection procedure.

13. A first cell, comprising:
one or more memories storing processor-executable code; and
one or more processors coupled with the one or more memories and individually or collectively operable to execute the code to cause the first cell to:
transmit, to a user equipment (UE), control signaling that indicates a cell reselection configuration to reduce triggering of cell reselection procedures at the UE based at least in part on a mobility state of the UE satisfying a threshold mobility state, the cell reselection configuration comprising a set of conditions to determine one or more scaling factors based at least in part on the mobility state of the UE, the one or more scaling factors usable to determine whether or not to perform cell reselection procedures at the UE; and
perform, or refrain from performing, a cell reselection procedure for the UE from the first cell to a second cell based at least in part on the one or more scaling factors of the cell reselection configuration.

14. The first cell of claim 13, wherein the set of conditions to determine the one or more scaling factors comprise one or more thresholds to evaluate the mobility state of the UE, wherein the one or more thresholds are associated with a rate of change, a magnitude of change, or both, of measurements performed by the UE on signals received from the first cell.

15. The first cell of claim 13, wherein the one or more scaling factors are usable to determine one or more cell reselection criteria to evaluate the cell reselection procedure, the one or more cell reselection criteria comprising a cell signal strength metric or a cell signal quality metric associated with the first cell, the second cell, or both, a cell reselection timer associated with an evaluation of the cell reselection procedure, a cell ranking metric associated with the first cell or the second cell, or any combination thereof.

16. The first cell of claim 13, wherein the one or more processors are individually or collectively further operable to execute the code to cause the first cell to:
transmit, to the UE, a second cell reselection configuration to increase triggering of cell reselection procedures at the UE based at least in part on the mobility state of the UE, the second cell reselection configuration comprising a second set of conditions to determine the one or more scaling factors based at least in part on the mobility state of the UE, wherein performance, or lack of performance, of the cell reselection procedure is based at least in part on the cell reselection configuration or the second cell reselection configuration.

17. The first cell of claim 16, wherein the one or more processors are individually or collectively further operable to execute the code to cause the first cell to:
transmit, to the UE, a paging message that includes information for selecting one of the cell reselection configuration or the second cell reselection configuration, wherein performance, or lack of performance, of the cell reselection procedure is based at least in part on the paging message.

18. A method for wireless communications at a user equipment (UE), comprising:
receiving, from a first cell, control signaling indicating a cell reselection configuration to reduce triggering of cell reselection procedures at the UE based at least in part on a mobility state of the UE satisfying a threshold mobility state, the cell reselection configuration comprising a set of conditions for determining one or more scaling factors based at least in part on the mobility state of the UE, the one or more scaling factors usable for determining whether or not to perform cell reselection procedures at the UE;
performing measurements on signals received from a second cell; and
performing, or refraining from performing, a cell reselection procedure from the first cell to the second cell based at least in part on the measurements and the one or more scaling factors of the cell reselection configuration.

19. The method of claim 18, wherein the one or more scaling factors are usable for calculating one or more cell reselection criteria, the one or more cell reselection criteria comprising a cell signal strength metric, a cell signal quality metric, a cell ranking metric, or any combination thereof, associated with the second cell, the method further comprising:
determining a negative scaling factor for calculating the cell signal strength metric, the cell signal quality metric, the cell ranking metric, or any combination thereof, in accordance with the set of conditions and based at least in part on the mobility state of the UE, wherein refraining from performing the cell reselection procedure is based at least in part on the negative scaling factor.

20. The method of claim 18, wherein the one or more scaling factors are usable for calculating one or more cell reselection criteria, wherein the one or more cell reselection criteria comprise a cell reselection timer associated with an evaluation of the cell reselection procedure, the method further comprising:
determining a scaling factor that is greater than one for calculating the cell reselection timer in accordance with the set of conditions and based at least in part on the mobility state of the UE, wherein refraining from performing the cell reselection procedure is based at least in part on the scaling factor that is greater than one.
